(19) United States
(12) Patent Application Publication
(10) Pub. No.: US 2014/0040368 A1
(43) Pub. Date: Feb. 6, 2014

(54) SYSTEMS AND METHODS OF ONLINE SOCIAL INTERACTION

(71) Applicant: Olivier Maurice Maria Janssens, Monaco (MC)

(72) Inventor: Olivier Maurice Maria Janssens, Monaco (MC)

(21) Appl. No.: 13/804,045

(22) Filed: Mar. 14, 2013

Related U.S. Application Data
(60) Provisional application No. 61/680,217, filed on Aug. 6, 2012.

(51) Int. Cl. H04L 29/08

(52) U.S. Cl. CPC H04L 67/306
USPC 709/204

(57) ABSTRACT

Methods and systems are provided for enabling users to identify other users of interest. An initial ordering of potential users of interests may be based on one or more criteria. The ordering may be modified in response to one or more events. A profile feed of potential matching users may be provided to a user wherein the ordering of the feed may be based on the modified ordering.

### CROSS-REFERENCE TO RELATED APPLICATIONS

This specification claims priority as a non-provisional application of U.S. Prov. Pat. App. No. 61/680,217, filed Aug. 6, 2012, entitled SYSTEMS AND METHODS OF MANAGING RELATIONSHIP MATCHING. The aforementioned application is hereby incorporated by reference in its entirety.

### BACKGROUND

Conventional systems, such as online matchmaking systems, enable users to find potential dates or life partners. However, such conventional systems often present information in a cumbersome, non-intuitive manner, and do not provide adequate interfaces via which a user can interact with a potential date or life partner.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Disclosed herein are systems and methods that may provide a user-friendly and efficient way for a user to find people or items of interest. For example, certain embodiments facilitate the process of people meeting and interacting with each other. By presenting an easy to use and intuitive user interface in conjunction with advanced processes for introducing users on the system to each other, certain embodiments may engender an efficient and friendly environment for interacting with others and/or potentially forming long-term and/or romantic relationships.

An example aspect includes a matching system, the matching system comprising: at least one computing device; non-transitory memory storing instructions, which when executed by the at least one computing device, are configured to cause the matching system to perform operations comprising: receiving profile information for a first plurality of users; determining that a first user in the first plurality of users is accessing a first user interface; identifying a plurality of matching users from the first plurality of users based at least in part on the received profile information; ranking the identified plurality of matching users based at least in part on a first criterion; determining an ordering in which respective profile information of the identified plurality of matching users are to be presented in a first area of a first user interface to the first user based at least in part on respective rankings; based at least in part on the determined ordering, causing, at least in part, profile information regarding a first matching user to be presented in the first area of the first user interface in association with a communication initiation control; subsequent to causing, at least in part, the profile information regarding the first matching user to be presented in the first area, causing at least in part profile information regarding a second matching user to replace the profile information of the first matching user in the first area, wherein the profile information of the second matching user is displayed in association with the communication initiation control; at least partly in response to detecting that the first user has initiated the communication initiation control while the profile information of the second matching user is displayed in the first area, enabling the first user to communicate with the second matching user; and at least partly in response to one or more of the following, re-ordering at least a portion of the identified plurality of matching users: at least one of the identified plurality of matching users indicating an interest in the first user; or at least one of the identified plurality of matching users visiting a profile of the first user; or at least one of the identified plurality of matching users providing a gift to the first user; or at least one of the identified plurality of matching users providing a request that respective profile information of the at least one of the identified plurality of matching users be provided with enhanced placement; based at least in part on the re-ordering, causing, at least in part, profile information regarding a third matching user to be presented in the first area of the first user interface in association with the communication initiation control.

An example aspect includes a computer implemented method, comprising: receiving at a computing system profile information for a first plurality of users; determining by the computing system that a first user in the first plurality of users is accessing a first user interface; identifying by the computing system a plurality of matching users from the first plurality of users based at least in part on the received profile information; ranking by the computing system the identified plurality of matching users based at least in part on a first criterion; determining by the computing system an ordering in which respective profile information of the identified plurality of matching users are to be presented in a first area of a first user interface to the first user based at least in part on respective rankings; based at least in part on the determined ordering, causing at least in part by the computing system, profile information regarding a first matching user to be presented in the first area of the first user interface in association with a communication initiation control; subsequent to causing, at least in part, the profile information regarding the first matching user to be presented in the first area, causing at least in part profile information regarding a second matching user to replace the profile information of the first matching user in the first area, wherein the profile information of the second matching user is displayed in association with the communication initiation control; at least partly in response to detecting by the computing system that the first user has initiated the communication initiation control while the profile information of the second matching user is displayed in the first area, enabling the first user to communicate with the second matching user; and at least partly in response to one or more of the following, re-ordering by the computing system at least a portion of the identified plurality of matching users: at least one of the identified plurality of matching users indicating an interest in the first user; or at least one of the identified plurality of matching users visiting a profile of the first user; or at least one of the identified plurality of matching users providing a gift to the first user; or at least one of the identified plurality of matching users providing a request that respective profile information of the at least one of the identified plurality of matching users be provided with enhanced placement; based at least in part on the re-ordering, causing at least in part by the computing system, profile information regarding a third matching user to be presented in the first area of the first user interface in association with the communication initiation control.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 is a block diagram of an example network including a social interaction system.

FIG. 2 is a block diagram of an example computing system as used in an embodiment.

FIG. 3 is an example user interface showing a contact list, chat pane, and card-feed display.

FIG. 4 is an example user interface on a mobile device.

FIG. 5 is a block diagram of an example data structure for a user account.

FIG. 6 is a block diagram of an example data structure for a card in a card-feed.

FIG. 7A is a block diagram of example data structures representing a card-feed being displayed.

FIG. 7B is a block diagram of example data structures representing an example card-feed and an example contact card being displayed.

FIG. 8 is a state diagram flowchart of an example process of navigating through a card-feed.

FIG. 9 is a flowchart of an example process of selecting a new card to add to a card-feed.

FIG. 10 is a flowchart of an example process of selecting a special card.

FIG. 11 is a flowchart of an example process of selecting an active card.

FIG. 12 is a flowchart of an example process of selecting a general card.

FIG. 13 is an example user interface showing a contact list.

FIG. 14 is a flowchart of an example process of constructing a contact list.

FIG. 15 is a flowchart of an example process of entering a speed-dating activity.

FIG. 16 is a flowchart of an example process of operating a speed date.

FIG. 17 is an example user interface during a speed-dating activity.

### DETAILED DESCRIPTION OF SPECIFIC EMBODIMENTS

Disclosed herein are systems and methods that may provide a user-friendly and efficient way for a user to find people and/or items of interest. For example, certain embodiments facilitate the process of people meeting and interacting with each other (e.g., for the purposes of potentially forming long-term and/or romantic relationships). Certain embodiments enable a user to identify items of interest, such as real estate, and to interact with a person representing the item (e.g., an owner or agent). For example, certain embodiments enable a user to communicate with another user via text chat, audible/verbal communication, video conferencing, gifts, viewing user profiles, providing like indications (e.g., to indicate whether one user finds the other user interesting), etc., as described in greater detail herein.

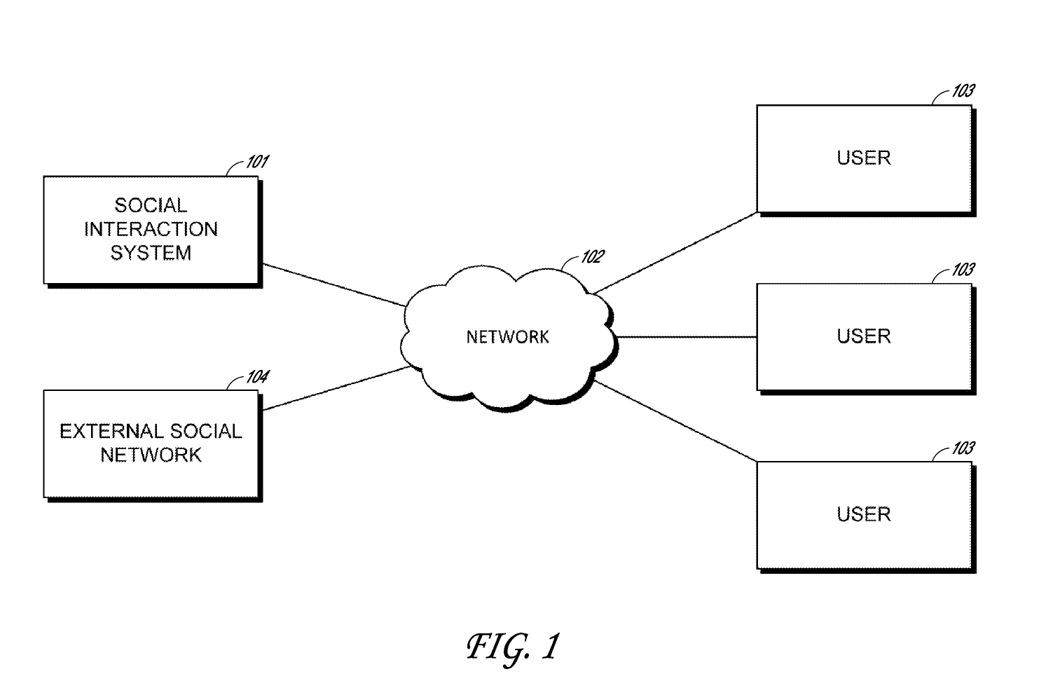

FIG. 1 is a block diagram of an example network including an example social interaction system. In various embodiments, additional functional blocks may be included, some functional blocks may be removed, and/or functional blocks may be connected or arranged differently from what is shown.

Social interaction system 101 is a computer system including one or more computing devices with computing hardware such as processors and memory, and with software stored in memory. The system 101 may provide various services for social interaction between users. The users may have accounts on the system 101. The system 101 may operate processes as described elsewhere herein, and it may further host network content, such as executable scripts, configured to be executed on user terminals (e.g., computers, mobile phones, interactive televisions, gaming devices, or other devices) to perform further processes described herein.

Social interaction system 101 may include one or more network interfaces for communicating with and over network 102, which may be, for example, the Internet, a LAN, a WAN, a virtual private network, and/or any combination of these networks or other networks. Through network 102, social interaction system 101 may communicate with users 103, who may operate computing devices such as desktop computers, mobile devices, tablet computers, and the like. The term “user” as used herein may refer to a user device and/or the operator of the device, as appropriate in context.

For example, a user may be an entity that is using a user-interface being displayed on a terminal (e.g., a computing device including a display, such as a smart phone, laptop computer, desktop computer, tablet computer, interactive television, etc.), or who is a member of the services being offered by the system. For example, in the case of an online dating system, a user may see other users' information, provide information for other users to see and/or interact with other users. A user may have a profile accessible by the system and some or all of which may be displayed to other users. The term “user” may refer, as appropriate to the context, to a computing device such as a general purpose computer or mobile phone; or it may refer to an entity such as a person who is operating the computing device. A person could operate the system for his own personal benefit or for a corporation for example, depending on the application. The system may perform a verification process to verify that a user is who she claims to be.

The social interaction system 101 may further communicate with external systems such as external social network 104. This may enable the social interaction system 101 to automatically authenticate users and/or gather profile information. For example, system may communicate with an organization, such as a social networking site, that verifies that the user is who he claims to be. Other external systems that may communicate with social interaction system 101 include chat systems, public data sources, blogs, microblogs, social media systems, and so on.

The system may determine if a certain user can access a certain resource/functionality based on user permissions. For example, administration users may have access to more modules and functionality than non-administration users. By way of further example, premium users (e.g., that have paid a fee to the operator of the system) may have access to more modules and functionality than non-paying members. By way of yet further example, the system may determine whether a given user has provided a specified threshold amount and/or type of profile information. If the system determines that the user has not provided the specified threshold amount and/or type of profile information, the system may limit the amount and/or type of other users' information the user may access. By way of still further example, if a first user has indicated an interest in a second user, at least partly in response, the system may provide the first user with access to additional information regarding the second user.

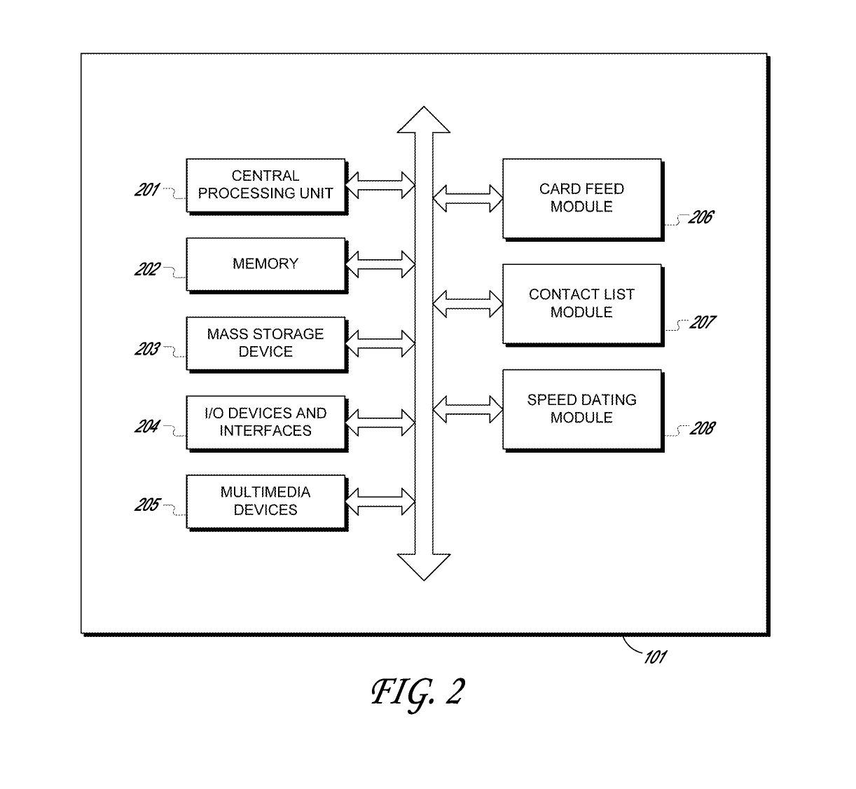

FIG. 2 is a block diagram of an example computing system as used in an embodiment. In various embodiments, additional blocks and functionality may be included, some blocks and functionality may be removed, and/or blocks and functionality may be connected or arranged differently from what is shown.

The computing system of FIG. 2 may comprise, for example, social interaction system 101 and/or another computing system. Social interaction system 101 may be one or more computing devices, including computer hardware. Social interaction system 101 may further include one or more modules which may be implemented as executable instructions in software and/or hardware such as circuitry.

The social interaction system 101 may be a general purpose computer using one or more processors 201, such as, for example, a microprocessor. The computer may run a variety of operating systems that perform operating system functions such as, for example, opening, reading, writing, and closing a file. The operating systems may control and schedule computer processes for execution, perform memory management, provide file system, networking, I/O services, and provide a user interface, such as a graphical user interface (“GUI”), among other things.

The social interaction system 101 may further include one or more memories 202, such as random access memory (“RAM”), for temporary storage of information, read only memory (“ROM”) for permanent storage of information, and/or a mass storage device 203, such as a hard drive, diskette, or optical media storage device. The memory 202 may store software code, or instructions, for execution by the processor 201 in order to cause the computing device to perform certain operations, such as gathering user profile data, processing the data to determine which users may be of interest to other users, enabling users to interact, formatting data for user devices or other presentation, transmitting data, or other operations described or used herein.

The methods described herein may be performed by any suitable computing device, such as the social interaction system 101. The methods may be executed on such suitable computing devices in response to execution of software instructions or other executable code read from a tangible computer readable medium or computer storage device. A computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

The social interaction system 101 may include one or more input/output (I/O) devices and interfaces 204, such as a keyboard, trackball, mouse, drawing tablet, joystick, game controller, touchscreen (e.g., capacitive or resistive touchscreen), touchpad, accelerometer, and/or printer, for example. The social interaction system 101 may also include one or more multimedia devices 205, such as a display device (also referred to herein as a display screen), which may also be one of the I/O devices 204 in the case of a touchscreen, for example. Display devices may include LCD, OLED, or other thin screen display surfaces, a monitor, television, projector, or any other device that visually depicts user interfaces and data to viewers. The social interaction system 101 may also include one or more multimedia devices, such as speakers, video cards, graphics accelerators, and microphones, for example.

In an example embodiment, the I/O devices and interfaces 204 provide a communication interface to various external devices via a network such as network 102 of FIG. 1. For example, the social interaction system 101 may be electronically coupled to the network 102 via a wired, wireless, or combination of wired and wireless, communication link(s). The network 102 may allow communication with various other computing devices and/or other electronic devices via wired or wireless communication links.

Social interaction system 101 may also include one or more modules which may be implemented as hardware or software including executable instructions. In an embodiment, social interaction system 101 includes card-feed module 206, contact list module 207, and speed-dating module 208. In various embodiments, additional modules may be included and/or any subset of these modules may be included. In various embodiments, one or more of card-feed module 206, contact list module 207, or speed-dating module 208 may be housed on separate computing devices connected via a network or other communications system. In an embodiment, each of the modules is optionally housed on a separate computing device thereby enabling different security settings for each computing device to be implemented for each of the modules. The modules perform various processes and operations as described throughout the specification.

An example user-interface may include two or more areas or panes. For example, a first pane or area may be configured to show cards (e.g., profile cards, gift cards, etc.) and card navigation controls, and another pane or area may be configured to display more high-level information. For example, in the case of an online dating application, the pane may display information relevant to communication with other users, such as a contact list, a chat window, a video conference window, etc. In a media application, the pane may, for example, show a list of available channels.

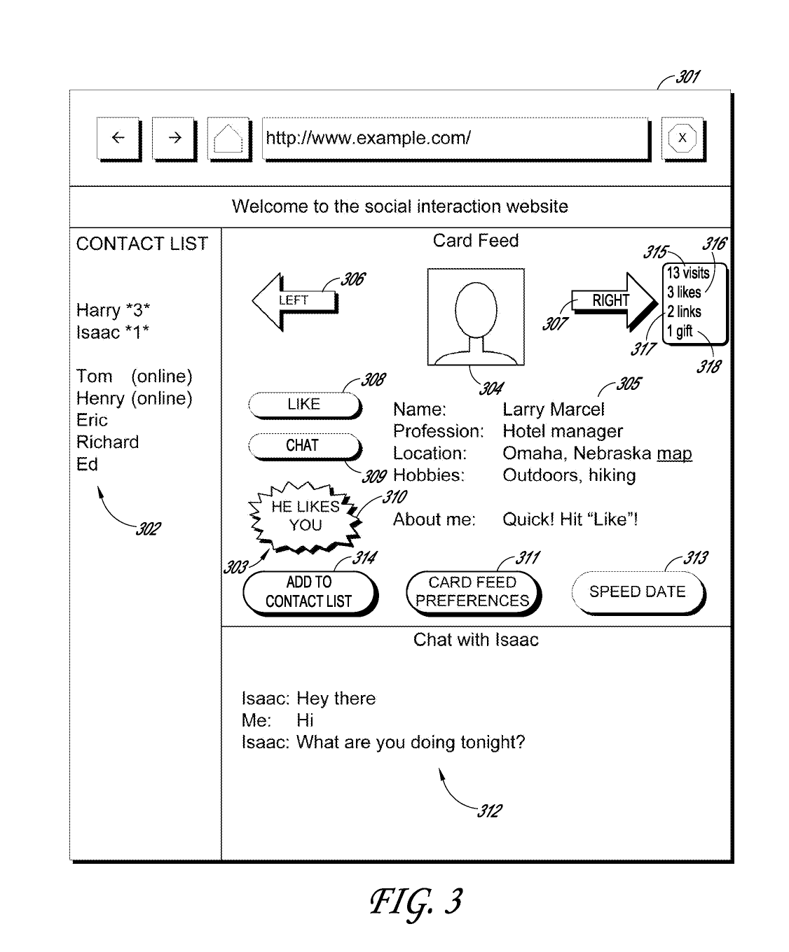

FIG. 3 illustrates an example user interface including a contact list, chat pane, and card-feed display. The user interface may be presented by social interaction system 101 of FIG. 1, for example, and may be shown as a home page or portal page for a user who is logged in. The interface may be presented in various formats compatible with various user devices, such as a web page, Flash content, XML, mobile interface, desktop application, and so on. In various embodiments, the elements of the interface may be differently arranged, additional elements may be included, and elements may be omitted.

As will be discussed in greater detail, the user interface may provide a dashboard style overview, and both high-level and detailed information may optionally be shown at the same time. For example, the user interface may display an overview list of a user's contacts as well as the detailed information of another user's profile at the same time. Optionally, the same user interface may further be configured to enable the user to both view information and communicate with other users, reducing or eliminating the need for the user to navigate to different pages or interfaces of a website or application to view more information and interact with other users of the system.

Interface 301 may be organized into several sections or panes. In the example embodiment shown, the interface includes overview section (e.g., which may provide high-level information to the user, such as contact list pane 302), card-feed pane 303, and chat pane 312. In an embodiment, the “right” or forward button 307 may optionally be on a separate navigation pane. The panes may be organized in columns, with the contact list pane 302 on the left, followed by chat pane 312, card-feed pane 303, and the navigation pane. Alternate organizations may be used.

Contact list 302 displays contacts associated with the user. The contacts may be other users on the system with whom the current user has some relationship with. Users may be added to the contact list in a variety of ways described herein. For example, other users may be added as a contact manually by the user (e.g., by activating an “add to contact list” control 314) and/or automatically by the system. For example, the system may automatically add highly compatible other users to the user's contact list, may add other users with whom the user has sent or received a chat message (e.g., by activating a “chat” control 309) or video conferenced with (optionally over a restricted period of time, such as the last 30 days, last 6 months, last year, etc.), or other users that the user liked or linked with, and/or otherwise.

Card-feed pane 303 displays “cards,” which may display profiles of users on the system, among other things. A card may include a profile image 304 (which may be in the form of a picture, drawing, icon, etc.). For example, the profile image 304 may be a photograph associated with the account of the user whose card is being displayed or an edited version thereof (e.g., cropped, reoriented, color corrected, etc.). In some cases, that user may have multiple pictures and/or other media such as videos or live webcam streams (e.g., wherein the webcam stream may optionally provide only video, and no audible information, to enable the viewer to view what the user is doing optionally without having two way communication). In an embodiment, the profile picture 304 may rotate through the various pictures and/or other media, in a circular order and/or randomly for example, enabling the card viewer to automatically view multiple images associated with a user's card. A card may also include profile information 305 (e.g., name, user name/alias, age, gender, gender preference, location, likes, dislikes, hobbies, user's text or video message, etc.) that other users can review. A card can contain one or more pages of information. Users that want to review other users' information can browse through the cards, as well as other information in various embodiments.

Cards are part of a “card-feed,” including a grouping (e.g., a series) of cards associated with respective users. The user of the card-feed may cycle through various cards within the card-feed to view images and profiles of other users (e.g., who the system determines the user may be interested in). For example, left (backward) arrow 306 and right (forward) arrow 307 may be provided to enable the user to view other cards within the card-feed. The algorithm for cycling through cards within a card-feed is described in detail further herein. The system may maintain a history of which cards a given user has viewed and the user's interactions with a given card. Different forms of user interaction may be used to indicate to the system that a new card or previously viewed card is to be displayed, such as clicking, mouse dragging, hovering, swiping, gesturing, and so on. In an embodiment, the feed is automatically cycled periodically, so for example a new card is displayed every few seconds or minutes. Thus, for example, the card-feed may operate as a screen saver, wallpaper, or lock screen, on a computer.

In an embodiment, right arrow 307 is optionally highlighted to prompt the user to proceed to additional cards in the card-feed. The highlighting may include blinking, coloration, bold text, increased size, and so on, as well as any combination of these. The highlighting may occur based on a specified condition, such as a user being new to the system, a time period of inactivity, the addition of new cards to the feed, an action by another user (such as that other user indicating a “like” for the current user), and so on.

As described above, clicking (or otherwise interacting with) left arrow 306 or right arrow 307 will replace the currently displayed card in the card-feed area 303 with another card in the feed. In an embodiment, an additional option is provided to allow the user to preview upcoming cards in the feed without dismissing the card being displayed. The user may then be able to select among the previewed cards or remain on the current card. For example, the previewed cards may optionally be displayed as thumbnails along a side of the user interface 301.

The user interface may also include an optional gallery with additional photographs, videos (including a visual track and optionally an audio track), and/or a live webcam connection (e.g., with or without an audio track for one-way communication or for two-way video conferencing communication), which may optionally be presented in thumbnail form, a like control 308, and/or a chat control 309 and/or an add to contact list control 314. A given card may automatically rotate through the different pictures (wherein a picture may be a photograph or other image) in the gallery at a predetermined or variable rate and optionally stop after one full rotation (or other specified number of rotations) through all the pictures. The user can select an individual picture by clicking on the thumbnail images or via other appropriate control. A user can report an offensive or abusive profile by activating a corresponding button. Optionally, in the illustrated example, the left side of the profile picture acts as the card-feed navigation left arrow and will move the feed one position backwards (except in the case of viewing profiles by clicking on the contacts in the contacts overview—in that case the left arrow (or other backwards navigation control) is optionally disabled). A filter list, with card feed preferences 311, may be provided which enables the user to specify filter criteria (e.g., setting a minimum or maximum age) that can alter which profile will be show next.

A card-feed may also display and/or maintain counters keeping track of activities by other users. For example, a visit counter 315 may be provided to keep track of the number of visits from other users to a given user's profile, a like counter 316 may be provided to keep track of the number of other users liking the given user's profile, a link counter 317 may be provided keeping track of the number of other users linking with the given user, a gift counter 318 may be provided keeping track of the number of gifts received by the given user from other users, or any other counters. Optionally, the system may provide an indication to the viewing user when a new user, that is considered potentially interesting to the viewing user, is added to the system (e.g., registers as a user). This indication may be provided in the form of an additional counter that shows the remaining number of users that the system has identified as potentially interesting to a viewing user and whose profiles have not yet been displayed to the viewing user, or the indication may be otherwise provided. The counters may track all past activity, activity for a specified time period, or may only count activity that the given user has not yet viewed, wherein when the given user has viewed the specific activity, the counter may decrement. Optionally, the system limits how information is provided to the given user, so that the only way for the user to be informed of which activities were performed or which other users performed activities (e.g., interactions) with respect to the given user's profile, may be to scroll through the card-feed. This may enhance the user's curiosity in learning what activities have taken place or which other users performed activities, and so may help to increase the user's usage of the system.

The user may be provided with further options to interact with the card shown in card-feed pane 303. For example, “like” button 308 records a unidirectional indication that the current user is interested in the user whose card is being displayed (even if the other user does not reciprocate). This indication may trigger multiple actions, such as adding the user whose card is being displayed to the current user's contact list. A user who has been liked may be notified of the identity of the user who indicated the “like,” may be notified of the existence of the “like” without disclosure of the user, or not notified at all, in various embodiments. Optionally, the user that liked another user may specify which of the foregoing actions are to take place. Optionally, the system provides a control via which the user can indicate a disinterest in another specified user. For example, if a viewing user A activates this control with respect to a profile card for user B, the profile card for user B may be excluded from user A's card-feed going forward, and optionally, if user B was a contact, user B may automatically be placed in ignored state and/or any future communication (e.g., chats, visits, likes, gifts, etc.) from user B to user A via the system is optionally not be shown to user A.

For example, badge 310 in the card-feed indicates that the user whose card is being displayed has previously indicated a “like” (e.g., an interest in the user being liked) for the current user, viewing the displayed card. Optionally in addition or instead, text or email messages may be sent to a user terminal to indicate “likes”. Optionally, when a user A is informed regarding another user (user B) liking his profile, optionally a link is also made available to user A, which if selected, causes the system to display user B's profile to user A. Optionally, a like counter 316 is provided, such that when other users “like” the user's profile, a like counter may increase its count. The user may activate a control (e.g., a go forward control) and the profile(s) of those that liked the user may be presented in the card-feed. Similarly, a link counter may be provided counting how many “links” a user has (where both users liked each other) and a badge 310 may be displayed indicating that the user linked with the other user (e.g., instead of displaying the like indication).

The user viewing card-feed pane 303 may further be enable the user viewing the card to chat with the user whose card is being displayed, for example by selecting “chat” button 309. As with the “like” button, this may trigger multiple actions in addition to initiating a chat session. For example, the user whose card is being displayed may be added to the current user's contact list as similarly discussed above.

The user may indicate preferences for the card-feed using card-feed preferences button 311. Preferences may affect the types of cards shown in the card-feed and/or the order in which cards are shown. For example, a user may specify limits on geographic region, age, sex, interests, religion, other criteria discussed herein, and the like.

Chat pane 312 enables the user to chat with other users. A chat session may be initiated using “chat” button 309, and/or the user may select contacts from contact list 302 to chat with. Multiple chat sessions may be simultaneously active, and the user interface may provide options for switching between various active sessions. Additionally, chat sessions may be integrated with external messaging systems, such as email, SMS, Instant Messaging, and so on to provide substantially real-time and/or non-real-time communication with other users. Rules may defined by users (e.g., in the users' account data or by a system administrator) indicating which users may chat with other users. For example, a user may specify that the user does not want to receive chat messages. By way of further example, a non-paying user may be denied chat functionality while a paying user may be provided chat functionality. Optionally, chat messages can be sent to both online and offline users. A received chat message may trigger different events in the system. For example, if a user directs a chat message to a recipient and the system determines that recipient is not logged into the system, the system may forward the chat message as an email to an email address associated with the recipient and/or as a short message (e.g., an SMS or MMS message) to the user's mobile telephone.

The user and/or administrator may specify the frequency of communications (e.g., emails and/or short messages, such as SMS or MMS messages) and/or what types of communications may be sent by the system and/or other users to the user. For example, communications may be generated by the system at times of the day and/or on specified days (e.g. a digest e-mail with user-specific relevant events that occurred that day) or triggered by actions taken by the user (e.g. sign up, lost password, being visited by someone, receiving a chat message while offline, etc.), or by other mechanisms.

“Speed-dating” button 313 enables the user to engage in online speed-dating. When the user selects this option, the user is enrolled in the speed-dating system, as described in detail further herein.

Additional features may be provided on this and/or other interfaces.

For example, optionally the system may be configured to auto-scroll through a person's pictures on a certain person's card. For example, when a user is first presented a card of a person, the system may automatically cycle through some or all of the pictures of that person, and then stop at the first picture (or other picture designated by the person or system as a primary picture). If a card also includes videos or a live web-cam interface, optionally, they may be included in the auto-scroll display. The user may be able to click on the picture, video, or web-cam content or a related control to continue viewing a certain picture, video or live webcam, and to halt or pause the auto-scroll feature.

Optionally, an online/offline indicator may be provided on a given card for a person in the feed, indicating to the user whether the person is online or not (e.g., is currently available for a video, voice, and/or text-based chat conversation).

Optionally, when a user logs in (e.g., for the first time), a symbol, such as a relatively large arrow, may be emphasized (e.g., via blinking), to clearly indicate to the user to click on the symbol to browse to the next profile.

Optionally, the user interface may be resized automatically when the browser is resized. Optionally, when a person's picture is clicked (e.g., in a chat and/or overview section of the user interface), the corresponding profile may be presented in the card-feed section of the user interface. A visit counter may be provided indicating how many other users have visited/viewed the user's profile. For example, the counter may increment with a given visit. Optionally, the visit counter only shows unique user visits (e.g., if the same user views the profile twice, the counter will only increment once). Optionally, a control may be provided enabling the user to instruct the system to present the card/profile of the user(s) that visited/viewed the user's profile.

Optionally, when the user links with another user (e.g., where both users indicated they liked the other user), a small image (e.g., a thumbnail picture) of the linked user previously or newly presented in the chat list or elsewhere may be highlighted or otherwise identified on the user interface (e.g., relative to images of other users in the chat list that are not a link). A card for the profile of the linking user may also be highlighted. For example, a small heart may be overlaid or presented adjacent to the profile card of the linking user.

Optionally, a link counter is provided for display, wherein when other users link with the user's profile, the link counter may increment its count to indicate how many other users have linked with the user. Optionally, a control may be provided enabling the user to instruct the system to present in the card-feed the card/profile of the linking user(s).

Optionally, a control is provided enabling a user to invite friends and to view which persons the friends like. Optionally, social voting functionality is provided, wherein a user may be able to vote on profiles together with other users, and see the results of the vote. This may be done live or semi-live. For example, a user interested in a given profile may ask friends to vote as to whether they like or dislike the profile. The votes may be tabulated and presented to the user.

Optionally, the system enables a user to select and provide gifts to a recipient user, where the user may be able to specify the recipient via a contact list or via a corresponding card for the recipient. These gifts may be selected from an online catalog, and optionally purchased via credit card, debit card, system credits, etc., or the gifts may be free. For example, the gifts may include a picture of a wine bottle, a video of flowers (e.g., moving in a breeze or being carried to a door), actual flowers, or a video of a puppy. Optionally, system credits may also be given as a gift. The gift may be shown on a card in the card-feed. For example, the gift may be shown either before or after the card of the user that gave the gift, or on the card of the user that gave the gift. Optionally, if the gift and the card of the user that gave the gift are shown simultaneously, the cards may be formatted differently (e.g., displaying less information) in order to provide room for the gift image.

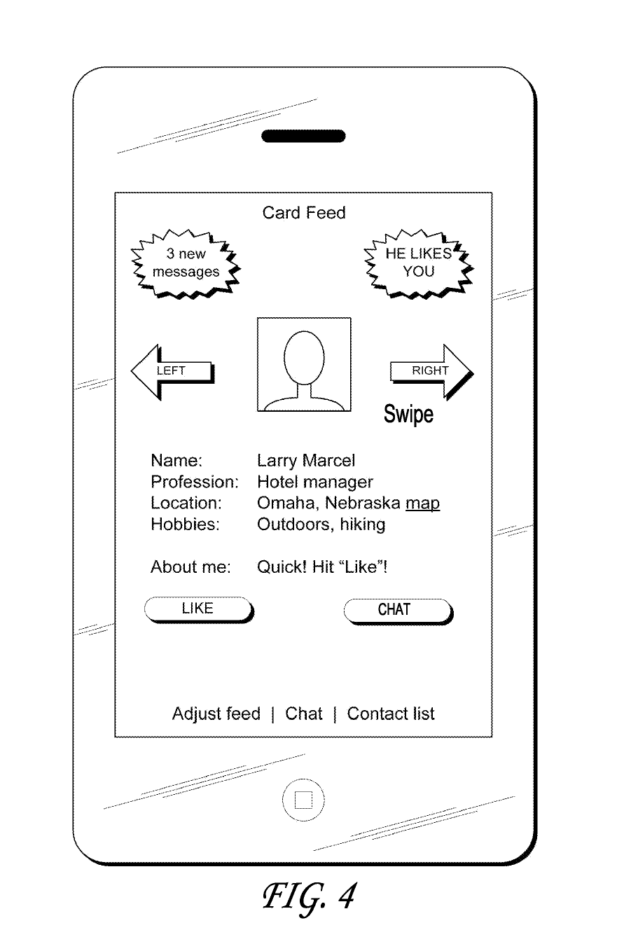

FIG. 4 is an example user interface configured for and displayed on a user mobile device. Mobile and other device interfaces may include the same or different features as those shown in FIG. 3, and they may be formatted differently to accommodate the specific device type. They may further use interactions specific to the device. For example, in the interface of FIG. 4, which is displayed on a device with a touch sensitive display, a card in a card-feed is shown, and the user may move between cards by swiping across the interface using a finger.

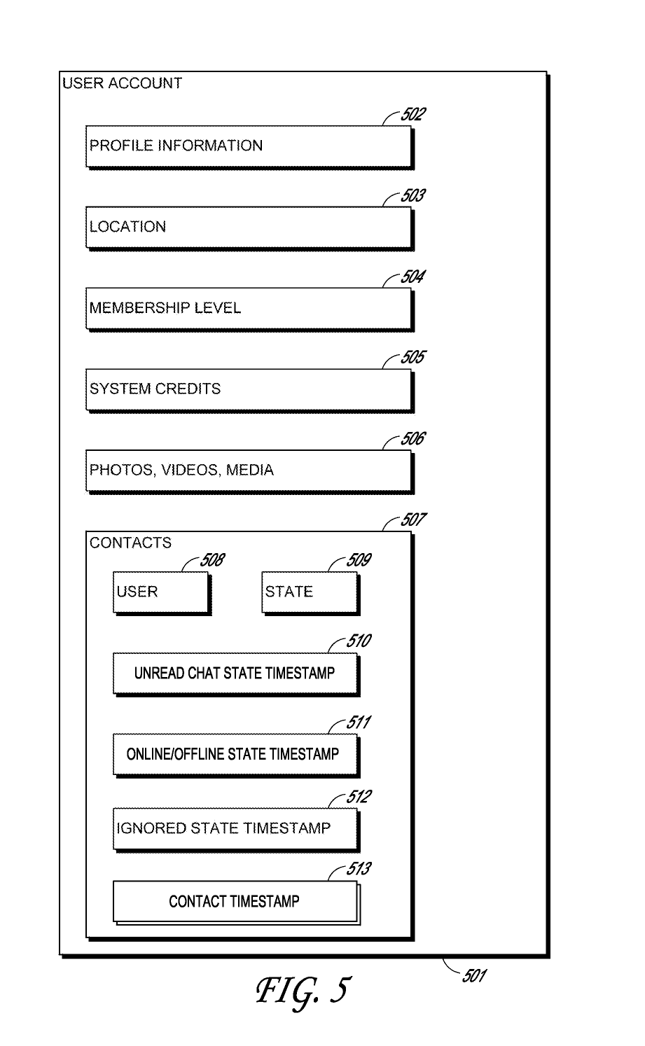

FIG. 5 is a block diagram of an example data structure for a user account. The data structure may be stored by social interaction system 101 of FIG. 1, for example. The data structure may be stored on computer-readable media such as a hard drive, SSD, tape backup, distributed storage, cloud storage, and so on, and may be structured as relational database tables, flat files, C structures, programming language objects, database objects, and the like. In various embodiments, additional elements may be included, some elements may be removed, and/or elements may be arranged differently from what is shown. In some embodiments, the elements may be separated across multiple associated data structures, rather than being encapsulated in a single structure.

User account data 501 may be used to represent a user with an account on the system. The data may include profile information 502, which may be used to store information to be displayed to other users on cards and/or profile pages. For example, the profile information may include but is not limited to: user's picture(s), user's name, user's age, user's gender, user's gender preference, user's location, hobbies, interests, likes, dislikes, food preferences, religion, income, employment, profession, political leanings, marital status, number of children, personality profile, and/or one or more messages from the user to be posted on the user's card. A profile may include one or more photographs, one or more profile videos and/or a live webcam connection. The profile information may include information provided by the user, information based on the user's activity on the system (e.g., on a site hosted by the system), and/or information obtained from other sources. A user may indicate, for potential “dates”, which location range he is interested in, which gender he is interested in, which age-range he is interested in, which interests he is interested in, other preferences discussed herein (e.g., sexual orientation, religion, profession, education, personality type, marital status, family status, personality, income), etc., and such indication may be stored in the user account data 501 in association with the profile information 502.

Location data 503 may identify a current location of the user. The location may be determined in substantially real time using geolocation services, such as IP geolocation (e.g., using the registered location of their IP address/ISP), mobile phone GPS systems, and so on. For example, the system may request GPS (Global Positioning System) location and compare received location information (e.g., latitude and longitude information) to a map of the world. Optionally, the system may receive the location from a third party authentication provider. The location may optionally be entered by the user manually. In an embodiment, the location is periodically updated to reflect movements of the user to different locations. The location information may be utilized by the system to identify other users within a user and/or administrator defined distance from the current location of the user, optionally even when the user did not manually provide the system with the user's location.

Membership level 504 indicates a level of membership associated with the user. Different levels of membership may entitle users to different levels of service, different features, and so on. The various levels of service may be based at least in part on one or more of the following parameters: a service fee amount, the length of a service contract, number of years as a member, etc.

For example, the system may distinguish between non-premium and premium members. Within the premium member category, there may be another distinction between different sub-levels (e.g., silver, gold, diamond, etc.). Optionally, users may start utilizing the system as a non-premium member for free. Such non-premium members may be provided with relatively more limited access to the functionality of the system as compared to premium, paying members. Optionally, a non-premium member may pay a fee to become a premium member. Various pricing techniques may be used. For example, a monthly payment may be charged to a user in order for the user to become or remain a premium member. Where there are different sub-levels of premium membership, a given level may have a corresponding price associated with it. In addition or instead, other payment processes may be used. For example, a user may be charged a yearly fee, a monthly fee, a weekly fee, a daily fee, or a lifetime fee.

All or some functionalities of the system may potentially be limited with respect to non-premium members. For example, non-premium members may be limited in one or more of the following ways (which may motivate a non-premium member to become a premium member):

if a user B has several photographs associated with his profile/card, a non-premium member A access to user B's profile/card may be limited to only being provided access to the first photograph on user B's card in the feed clearly. The other user B photographs may either not be shown to member A, or are shown to member A as a blurry or partially obscured image way, so it is clear that there are more pictures, but the content of the photographs are not clear, thereby motivating member A to become a premium member;

the system may limit the number of chats a non-premium member A may send per day (e.g., no more than a specified number of chat messages per day or other time period); or

if a user B has a video-profile on his card, a non-premium member A may be limited to only having a portion of the video played back to the user A (e.g., only the first 15 seconds of user B's video profile);

a non-premium member may be limited to only being permitted to perform a certain number of speed-dates per time period (e.g., one speed date per day) and/or if there is a mutual like with another user during the speed-date, the amount of time/chats the user A may be permitted may be limited to a first amount (e.g., user A may only be permitted to speak with the other user for 30 seconds or less after the end of the speed-date).

The system may include further features for receiving and managing payment for some or all features provided by the system. These may include, but are not limited to membership levels and system credits. For example, system credits 505 may be a form of virtual currency available to the user account. Virtual currency may be used to purchase various features (e.g., access to features) and items (e.g., gift-cards), as described below. Virtual currency may be used to purchase elevated membership levels 504.

System credits may be purchased by users and used to purchase items via the system (e.g., gifts for other users). For example, there may be a set purchase price per credit, and a package of credits may be specified and offered for sale (e.g., $10 for 10 credits, $50 for 100 credits, etc.). These credits may then be used to purchase or access specific functionalities on the system. For example “boosts” (enhanced profile/card placement as described in greater detail elsewhere herein) may be sold for credits. By way of further example, a fixed price may be specified for a boost to all the users in the user relevant universe, or to all users in the unviewed user relevant universe, or to all online users in the user relevant universe, or to any subset thereof. Optionally, the pricing may be per user reached with the boost. In this case, a boost that reaches more users would cost more than a boost that reaches fewer users.

Optionally, membership levels and system credits may be purchased via the system using real currency. Accordingly, the social interaction system may include a payment processing system to charge payment to users. In addition or instead, membership levels and/or system credits may be provided for non-monetary reasons, such as amount of time spent on the system, community reputation, and so on. Optionally, membership levels and/or system credits may also be provided for free, to provide the user with the experience of having and using such membership level or credits, and motivating the user to purchase additional credits or enhance membership level in the future.

A user may provide media, such as photographs, videos and/or a live webcam stream, to be associated with the user's account. These may be part of the profile information or may be stored separately in photo/video/media data 506. This data may be used for display on cards associated with the user. In an embodiment, the user may submit media and then select a subset to be shown on cards for the user. The subset to be shown may be customizable by the user. The order in which different photographs, videos and/or a live webcam stream are shown may also be customizable by the user. For example, the user can specify that different media is to be shown to different card viewers. For example, a user may specify that older viewers are to be displayed more professional, formal photographs, and younger viewers are to be displayed more casual photographs. By way of further example, a user may specify that other users that like the user can see more of the photos/videos/live webcam stream material uploaded than users that have not indicated that they like the user. Other media may also be associated with a user account, such as audio, 3D renderings, text, HTML content, and so on.

For example, one or more techniques may be provided enabling the user to upload photographs and/or videos to the system. For example, the system may enable the user to upload a file from the user's computing device's local memory, upload a substantially live image or recorded image directly from a camera (which may be connected to the user's computer system) such as a webcam or camera phone, or from an online photo album (e.g., from a social network site or photo album site). Optionally, before or after the upload occurs, a photo editing application may automatically edit the photographs (e.g., automatically crop and scale the photographs and/or videos to better fit a given user interface or display device) or may let the user edit the photographs himself.

Optionally a photograph and/or video review and approval process may be performed. For example, some or all of the uploaded photographs and/or videos may be displayed to the user via a user interface, and may not be immediately published for viewing by others, pending review and approval. The photographs and/or videos may be added to a review queue and reviewed by an automated process and/or a human. For example, the photographs may be reviewed to ensure that do not include offensive subject matter (e.g., nudity), that the photographs are of decent quality (e.g., not too dark or blurry), and/or that the subject of the photograph appears to be that of the user (e.g., by comparing the age provided by user to the apparent age of the person in the photo). If the photographs and/or videos are rejected, the user may be notified of the rejection and the reason for the rejection, and optionally the photographs are deleted from memory and/or are not published to the site for viewing by other users. If the photographs are approved, they may be published for viewing by others (e.g., in search results, on profile cards, etc.).

A number of contacts 507 may also be associated with a user account. The contacts may be used to generate contacts list 302 illustrated in FIG. 3, for example. A contact record 507 may indicate the user 508 who is the contact. A contact record 507 may thus constitute a self-join on a table of users, connecting users with each other unidirectionally.

Contact record 507 may further indicate a state 509 of the contact. The state may indicate the current activity of the user 508. In an embodiment, the state is selected from the following possible states: unread chat state, online state, offline state, and ignored state. Other states and/or any subset of these states may be permitted, and multiple states may be associated with a contact record in various embodiments.

Contact record 507 may further include various timestamps, such as unread chat state timestamp 510, online and offline state timestamps 511, ignored state timestamp 512, and contact timestamp 513. These timestamps may correspond to various events. For example, the unread chat timestamp 510 may correspond to the time when user 508 last sent a message that has not been shown to the user yet, the online and offline timestamps may indicate the time when the user went online or offline, the ignored state timestamp may indicate the time when the user was set to be ignored by the user (e.g., by activating an ignore control) associated with account 501 and the contact timestamp may indicate when user 508 became a contact of the user associated with account 501. Contact record 507 may include other timestamps as well. Timestamps may be omitted in some situations, such as where the user's state is incompatible with the timestamp event (for example, the unread chat timestamp may be deleted if there are no unread messages). The timestamps may be absolute timestamps indicating a time of the occurrence of an event, or relative timestamps indicating an amount of time elapsed since the event. The timestamps may be used for sorting contacts in the contact list according to time (e.g., less recent to more recent, or more recent to less recent). Thus, in addition to or instead of storing a timestamp, the system may maintain an ordered list for the various events.

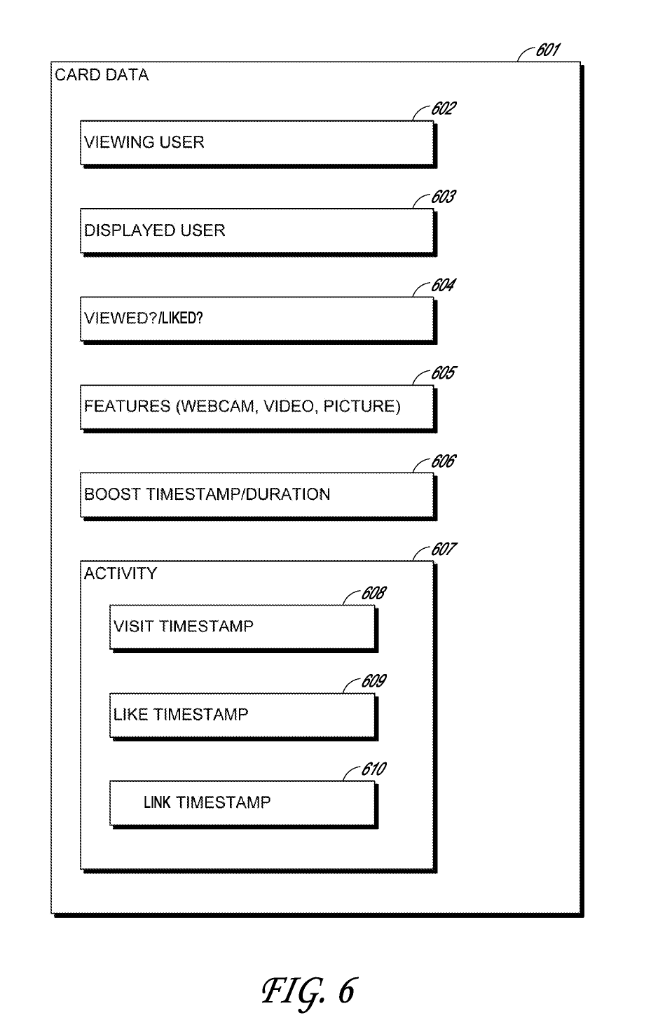

FIG. 6 is a block diagram of an example data structure for a card in a card-feed. The data structure may be stored by social interaction system 101 of FIG. 1, for example. The data structure may be stored on computer-readable media such as a hard drive, SSD, tape backup, distributed storage, cloud storage, and so on, and may be structured as relational database tables, flat files, C structures, programming language objects, database objects, and the like. In various embodiments, additional elements may be included, some elements may be removed, and/or elements may be arranged differently from what is shown. In some embodiments, the elements may be separated across multiple associated data structures, rather than being encapsulated in a single structure.

Cards about a user that are shown to a viewer may maintain a special state relating the user and the viewer, so that interactions between the user and the viewer may be maintained by the system. Thus, card data 601 may include references to the viewing user 602 and the displayed user 603 to link the two users. The remaining data elements of card data 601, and other data elements that may be included, may thus indicate aspects of the relationship between the users.

Flag 604 indicates whether the viewing user 602 has already viewed this card in the card-feed and/or whether he indicated he liked the profile in this card. The information regarding views in flag 604 may be used, for example, to determine whether to show the card to the viewing user 602 again. In an embodiment, each card is optionally placed in the card-feed only once, in which case flag 604 may be used to prevent the card from reappearing in the feed. Optionally instead, cards may be viewed multiple times, and flag 604 may be used to decrease (or increase) the likelihood that the card is shown again or the frequency with which the card will be shown. The information regarding likes in flag 604 may be used by the system, for example, to determine whether additional information on the card is to be shown to viewing user 602, in the embodiment configured so a viewing user is restricted to seeing basic profile information first, and after he likes a user whose card is displayed, the system may enable the user to access and view additional profile information.

Features indicator 605 may indicate a card type based at least in part on features available on the account of the displayed user 603. For example, three features may be identified: whether the displayed user has an active live webcam stream, whether the displayed user has a video, and whether the displayed user has a picture. Fewer or additional aspects of the user may be included in features indicator 605. The available features may be used for filtering and/or sorting cards in the card-feed (so that, for example, a user may restrict out cards that have no webcam, video, or picture).

In an embodiment, a user may perform a “boost” operation, which generally causes the user's cards to appear relatively earlier and/or more prominently in other users' card-feeds than the user's card would have absent the boost. The specific details of the boost operation are described further herein. Because the boost operation may be specific to certain viewers, the card data record may include a boost timestamp and/or duration indicator 606.

As similarly discussed above, a card in a card-feed may be associated with certain activities, indicating interactions between the viewing user 602 and the displayed user 603. These and other activities (e.g., visits, links, likes, ignores, gifts, boosts, chats, unread chats, contact additions, online states, offline states, entering a speed dating mode, etc.) may be recorded in activities data 607, which may include flags, absolute and/or relative timestamps, and/or other indicators of activity. For example, visit timestamp 608 may indicate the last time when the displayed user viewed the viewing user's card. This information may be useful as it may indicate a user's interest in another user. For example, when one user views a second user's card, there may be an increased chance that the second user will be interested in the first user. The visit timestamp may allow the application to track the order in which different users visited a given user (e.g., less recent to more recent, or more recent to less recent). The visit timestamp may be a relative timestamp (such as an amount of time elapsed since one user visited the given user's profile card), indicating whether the visit happened before or after a visit from other users, or an absolute timestamp that keeps track of the actual time the visit took place, or it may otherwise track when visits to the given user's card took place. When user A has seen the fact that user B visited him, the visit timestamp may be removed by the application.

Similarly, when the displayed user 603 indicates a “like” after viewing user 602, the time of the “like” event may be recorded in “like” timestamp 609. “Link” timestamp 610 may record a time when two users are “linked”. In an embodiment, two users are linked when both of those users indicate a “like” for the other, providing a bidirectional interaction. In such a case, both users may be added to each other's contact lists and/or they may be sent a notification message, sound, graphic, or the like.

In an example embodiment, the contact list contains identifiers associated with other users that the logged-in user has interacted with via the system in some way (optionally restricted to interactions over a certain period of time, such as the last 6 months or other time specified by the system operator or user). Optionally, a chat control may be provided on a given user's profile card (and/or elsewhere), which when activated adds the user to the contact list of the user that activated the chat control. Optionally, at substantially the same time, a chat window may open so that both users may now start chatting with each other. Optionally, a contact may also be automatically added to a given user's contact list when two users link i.e., when two users “like” each other. In an example embodiment, if user A “likes” user B, user B likes user A back, a link is created. The system may then add user A to the contact list of user B (and user B to the contact list of user A) and send a chat message to both users (for example saying “You both link”, or any other text). User B may also add user B to the contact list by activating an “add to contact list” control, which may be presented on user A's card.

In an embodiment, cards other than user relationship cards 601 may be included in the system. These may include system message cards and gift cards, for example. By way of example, with respect to gift cards, they may be implemented as a combination of two (or more) cards. For example, the system may enable a first user to send a gift to a second user that has not yet viewed the first user's profile card. By way of further example, the system may enable a first user to send a card with a gift for a second user that has not yet been shown to the second user and the card with the profile from the first user. The card with the gift may be show before the card with the profile, or the card with the profile may be shown before the card with the gift, or both cards (optionally in a smaller version) may be shown simultaneously to the gift recipient. A gift card may either be defined as shown or un-shown, depending on whether or not the card has already been shown to the recipient.

When a first user has given a gift to a second user, then in second user's card-feed, the gift-card may receive a gift timestamp. This gift timestamp may allow tracking of the order in which different users gave a gift to the second user (e.g., less recent to more recent, or more recent to less recent). This gift timestamp may be a relative timestamp (such as an amount of time elapsed since a user received the gift-card), indicating whether the gift was given before or after a gift from other users, or an absolute timestamp that keeps track of the actual time the gift was given, or any other technique of tracking when gifts occur. When a gift card has been displayed to the recipient, optionally the gift timestamp may be removed.

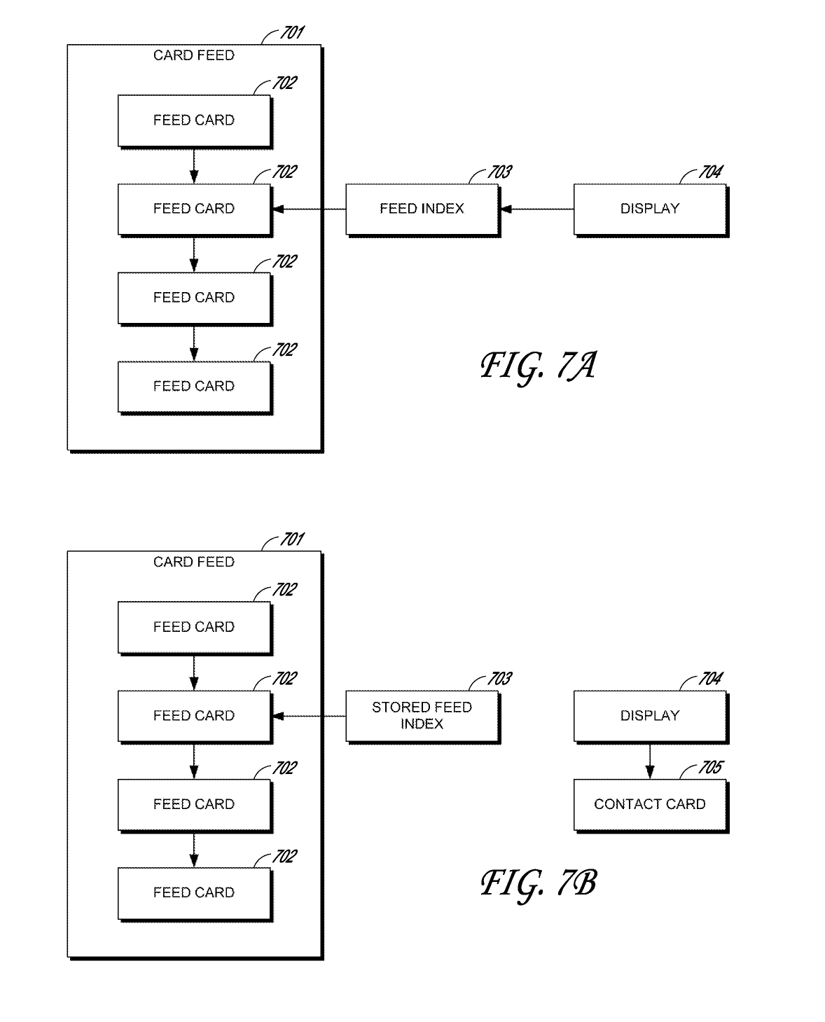

FIG. 7A is a block diagram of example data structures representing a card-feed being displayed. The data structures may be maintained on social interaction system 101 of FIG. 1, and/or they may be maintained on user devices 103 in accordance with executable code provided by the social interaction system or other system.

Card-feed 701 includes multiple feed cards 701, which may be structured as card data 601 of FIG. 6 for example. The cards 702 may be ordered into a list, which may be a linked list (optionally, a doubly linked list) for efficiency of traversal and modification. The order of the list may inform the process of cycling through the list as described previously with respect to controls 306 and 307 of FIG. 3. A feed index pointer 703 may identify a particular card on the card-feed 701, and display 704 may show the card indicated by feed index 703. Thus, as feed index 703 moves to point to different cards 702 in feed 701 (e.g., due to the user navigating through the feed, for example), the display 704 may be updated. The feed index pointer 703 may be represented as an object reference, a memory pointer, a numerical index into an array, and so on (the first two of these options being more compatible with linked lists).

It may be desirable to enable users to view cards of arbitrary users, such as users in the contact list. Since ordinary navigation of the feed index may not certainly or easily enable a user to retrieve a particular user's card, an additional feature may be included to enable a user to select a card without losing place in the navigation of the feed.

FIG. 7B is a block diagram of example data structures representing a card-feed and a contact card being displayed. In this example, card-feed 701 and cards 702 are still present as discussed with respect to FIG. 7A. However, display 704 no longer presents the card identified by feed index 703 (which may be placed on-hold), but rather card 705 is selected from the user's contact list (e.g., by clicking on a contact name or photograph) or elsewhere. The feed index 703 is stored, so that the display may later return to displaying the card-feed at the position from which it left off, and the on-hold card may be displayed, and will no longer be in an on-hold status. Optionally, if after viewing the contact card, the user selects a second contact card, the initial contact card is not put on-hold, and the card that was placed on-hold when the user selected the initial contact may still maintain the on-hold status. Optionally, it may be the card with the highest feed-index in the current feed that may be put on hold, rather than the card that has been displayed prior to the user selecting card 705. Other techniques may be used to select the on-hold card. Optionally, at most one on-hold card is maintained at a time for a user. Optionally instead, multiple on-hold cards may be maintained for a user. Optionally, if a contact card 705 is being displayed and a card 702 is put on-hold card, the backward navigation control (e.g., the left arrow) is disabled (e.g., not displayed, or grayed out and non-functional).

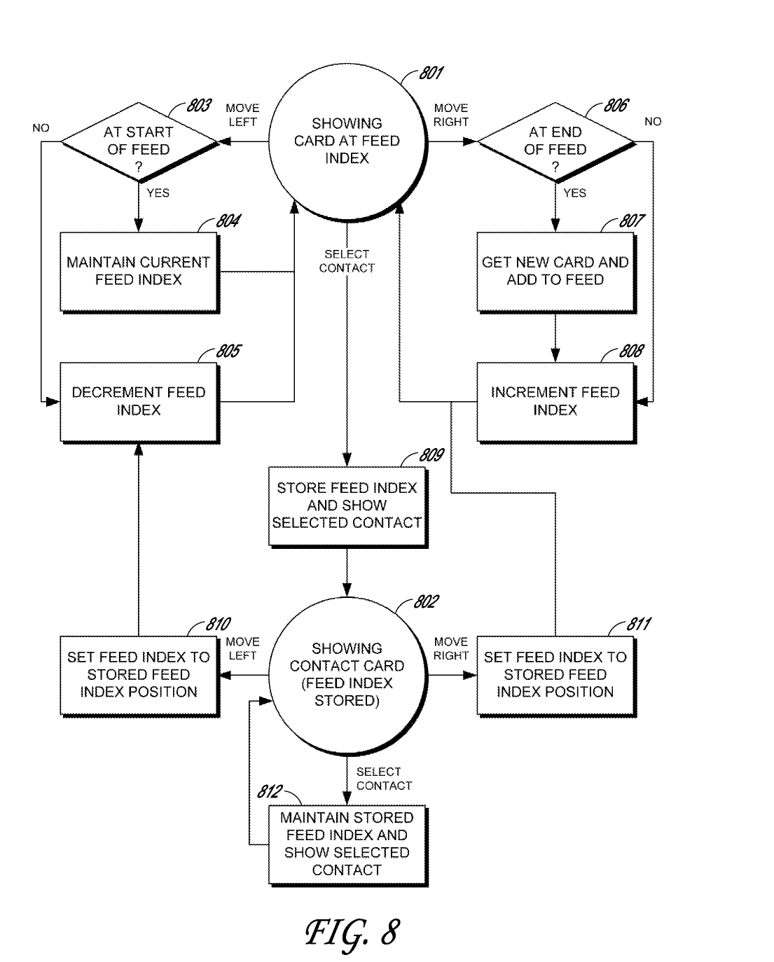

FIG. 8 is an example state diagram flowchart of a process of navigating through a card-feed, as used in an embodiment. The process may be performed by social interaction system 101 of FIG. 1, or by user devices 103 in accordance with executable code provided by the social interaction system, or other system, or any combination of the foregoing, for example. In an embodiment, some or all of the process of FIG. 8 is optionally performed by code (e.g., scripting code, such as JavaScript code), on a user device. The process may be used to display card-feed pane 303 of FIG. 3, for example. In various embodiments, additional states may be included, some states may be removed, and/or states may be connected or arranged differently from what is shown.

At any given time, the card-feed pane or other display may show either a card within the card-feed (as described with respect to FIG. 7A), or it may display a contact card or other user-selected card (as described with respect to FIG. 7B). The former situation is represented by state 801, and the latter situation is represented by state 802. In various embodiments, the card-feed pane or other display may show different information, and so other states may be applied.

At state 801 or state 802, the user may select among the following navigation options (although fewer, additional, or different options may be provided): the user may navigate right (e.g., forward through the dynamic feed), the user may navigate left (e.g., backward through the feed history), and the user may select to view a card of a specific contact or other user. Other navigation options may be presented, and some of the aforementioned navigation options may be unavailable for some or all of the states.

If the card-feed pane is at state 801, displaying a card in the feed index, and the user opts to navigate left (backwards in the feed), then at state 803 the system determines whether the feed index is pointing to the start of the feed. If so, then at state 804 the feed index is maintained in its current position, so that the card being shown is unchanged, as there are no earlier cards in the feed. Optionally, if the feed index is pointing to the start of the feed, than the backward navigation control (e.g., the left arrow) is disabled (e.g., not displayed, or grayed out and non-functional). Otherwise, at state 805 the feed index is decremented or otherwise moved to the preceding card in the feed, and that card is displayed. The process then returns to state 801, because a card in the feed is being displayed.

If the process is at state 801 and the user opts to navigate right, forward in the feed, then at state 806 the system determines whether the feed index is pointing to the end of the feed. If so, then at state 807 the system requests a new card to be added to the end of the feed. The procedure for selecting a new card is described in detail elsewhere herein. In an embodiment, multiple cards are added to the end of the feed, thereby reducing the number of card selection operations to be performed and improving performance. Optionally, if there will be noticeable delay in presenting a newly added card to the user, the system may cause a message to be presented to the user requesting the user to wait until a new profile card can be displayed. Then, at state 808, the feed index is incremented or otherwise moved to the next card in the feed (which presumably is a newly added card), and the new card is displayed, optionally substantially as soon as the new card is added to the feed. If the feed index is not pointing to the end of the feed at state 806, then the feed index is incremented at state 808 and the next card is displayed. Again, the display returns to state 801 because a card in the feed is being displayed.

If the card-feed pane is at state 801 and the user opts to display the card of a contact or other specific user, then at state 809 the current feed index is stored, and the card of the selected contact or other user is displayed. Because the display is now showing a card of a contact rather than a card in the feed index, the display enters state 802.

If the card-feed pane is at state 802 with a contact card being shown, and the user opts to navigate left (backward in the feed), then at state 810 the stored feed index position is restored, and it is decremented at state 805. Thus, the display is updated to show the card preceding the one that was shown before the contact card was selected. Because a card in the feed is now being displayed, the display enters state 801. Optionally, if the card-feed pane is at state 802, than the backward navigation control (e.g., the left arrow) is disabled (e.g., not displayed, or grayed out and non-functional).

If the card-feed pane is at state 802 and the user opts to navigate right (forward in the feed), then at state 811 the feed index position is set to the stored feed index position, and the card at that position in the feed is displayed. Thus, the display is updated to show the card that was shown before a contact card was selected. Because a card in the feed is now being displayed, the display enters state 801. Optionally, it is also possible that the feed index position is set to the stored feed index position plus one (e.g., instead of showing the card that was shown before a contact was selected, the system will show the card in the feed after the one that was shown before a contact was selected).

If the card-feed pane is at state 802 and the user opts to view the card of another contact or user, then at state 812 the stored feed index is maintained, and the newly selected contact is shown. Because the display continues to show a card of a contact, the display remains in state 802.

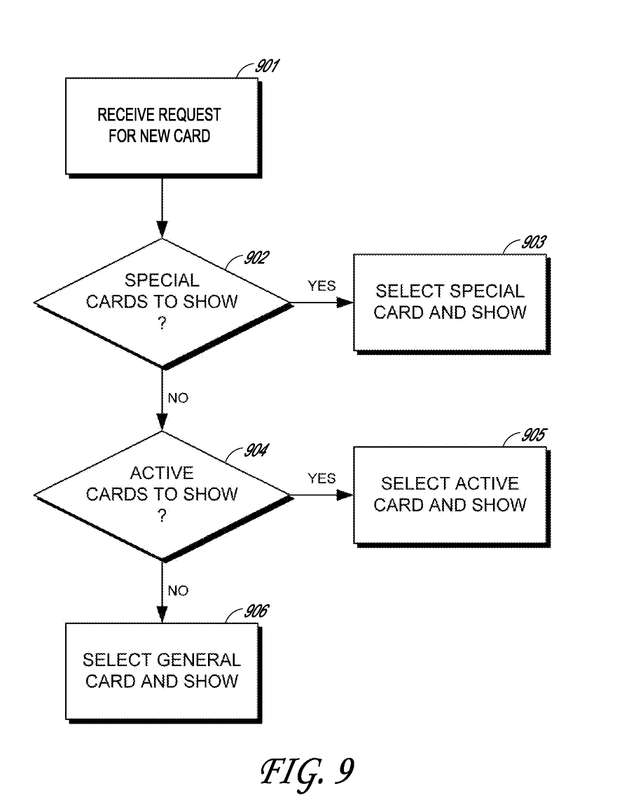

FIG. 9 is a flowchart of an example process of selecting a new card to add to a card-feed, as used in an embodiment. The process may be performed by social interaction system 101 of FIG. 1, for example. The process may be performed at state 807 of FIG. 8, for example. In various embodiments, additional states may be included, some states may be removed, and/or states may be connected or arranged differently from what is shown.

At state 901, a request is received for a new card to be added to the card-feed. In an embodiment, the request is received from a user device. For example, the request may be triggered by code (e.g., scripting code) executing on the user device.

At state 902, the system determines whether there are any special cards to be displayed. If so, then at state 903 the system selects a special card to display, and causes, at least in part, the card to be displayed on the user devices. The system may cause the card to be displayed by constructing and transmitting appropriate card data (such as the data shown in FIG. 6) to the requesting user device. Where the process of FIG. 9 is performed on a user computer, the card data may be directly displayed to a display device. The foregoing process of displaying a card is applicable to other cards described as being “displayed” herein.

If there are no special cards to show, then at state 904, the system determines whether there are any active cards to be shown. Active cards are those in which an interaction between the displayed user and the viewing user has occurred and this activity has not yet been shown to the viewing user. Cards may be identified as “active” based at least in part on activity data 607 of FIG. 6. If an active card is present, then at state 905 an active card is selected and provided for display.

If there are no special or active cards to show, then at state 906, a card is selected from the remaining available universe of cards (cards identified by the system as potentially interesting to the viewing user), and it is displayed to the viewing user. In some cases, there may be no appropriate card to display at state 906, in which case the user may be notified to wait till a new card becomes available and/or prompted to modify card-feed parameters. In the case the user is notified and is waiting for new cards, when a new card becomes available, it may be shown substantially immediately to the viewing user, without the viewing user having to give any instruction to the system.

Additional considerations may be incorporated into the process of selecting cards for the card-feed. For example, repeated clicking of a card-feed navigation forward control (e.g., the right arrow) by the user may enable the user to progress forward through the card history, optionally one card at a time. When the user has reached the last card in the feed and wishes to see a new card, clicking the card-feed navigation forward control causes a new card, selected by the system, to be presented to the user. The system may utilize an intelligent algorithm to sort and/or rank the cards. For example, a higher ranking may be assigned to card that is determined or estimated to be of greater interest to the user than the ranking of a card determined or estimated to be of relatively less interest to the user. In an example embodiment, cards that are estimated or determined to be more interesting for the user (e.g., have a higher ranking) are shown relatively sooner, and cards that are estimated or determined to be less interesting (e.g., have a lower ranking) are shown relatively later. Various metrics to determine whether one card is more “interesting” than another may be applied, examples of which are described elsewhere herein.

Optionally, the algorithm is configured to decide which card will be shown next or to change the order of priority of the different types of cards in the system. Other data that may be included in the determination as to which card to show next or the card ordering, may be for example user membership level, degree/amount of common interests, the number of common friends (e.g., as determined from a social networking site), etc. Optionally, a point-system is incorporated, where different data used in determining a ranking/which card to display next is assigned a respective weighting (e.g., a certain amount of points), and the card with the highest amount of points (highest ranking of not yet shown cards) may be shown next.

Additionally, system messages (for example including information from the system and/or advertisements) may be provided for display in between cards from users, and/or certain users may make their card more prominent through “boosting,” in which a “boosted” card may be shown to other users sooner than it might otherwise have been shown based on the determined or estimated interest to the users. To determine and select which card to show, the algorithm may use information including but not limited to: user settings (e.g. which kind of other users are considered interesting by the user), past interactions between users (e.g. if a user visited, liked, linked with, and/or gave a gift to another user), whether a user is online or offline, the type of information included in a user's own profile (e.g., the user's picture(s), video, name, age, gender, gender preference, location, likes, dislikes, hobby's, user's message, etc.), the user's geo-location, whether another user boosted his card and/or additional criteria that makes a card more likely to be presented to other users. In various embodiments, information about other users may be used as well as information about the user; for example, the algorithm may select a potential link based on links selected by other users similar to the user. For example, when another user visits the user's profile card, the user may go forward in the feed by selecting the forward control, and the process may select the visitor's card as the next card to display to the user in the card-feed. Similarly, when another user “likes” the user's profile card, the user may go forward in the feed by selecting the forward control, and the process may select the card of the person that liked the user as the next card to display to the user in the card-feed.

Optionally, the algorithm is configured to decide which card will be shown next or to change the order of priority of the different types of cards in the system. Other aspects that may be included may be for example membership level, common interests, common friends on Facebook, etc. Optionally, a point-system is incorporated, where different aspects each give a certain amount of points, and the card with the highest amount of points may be shown next.

There are several aspects related to the card-feed algorithm which may be taken into account in deciding which cards are to be presented when. These may include but are not limited to one or more of the following:

Age Selection: A user may specify an age filter via a filter user interface presented to the user, which limits which cards will be shown to the user, based at least in part on the age range selected by the user (e.g., including an upper and/or lower age bound).

Picture Filter Selection: The system may automatically filter people from the feed that do not have associated images, photographs, and/or videos. Optionally, the filtering is in response to an instruction or preference specified by the user via the filter user interface or otherwise.

Feed Block: Optionally, the system may block a user from advancing the feed (e.g., by deactivating or not providing a forward feed control) unless the user provides certain data, such as an upload of a picture of the user, biographical data, demographic data, etc.

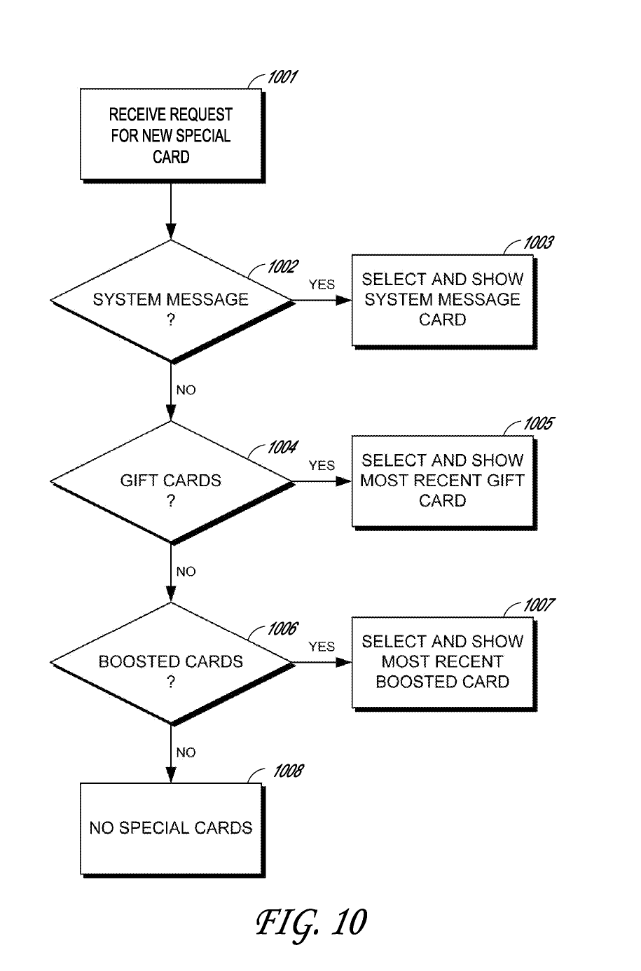

FIG. 10 is a flowchart of an example process of selecting a special card, as used in an embodiment. The process may be performed by social interaction system 101 of FIG. 1, for example. The process may be performed at states 902 and 903 of FIG. 9, for example. In various embodiments, additional states may be included, some states may be removed, and/or states may be connected or arranged differently from what is shown.

At state 1001, a request to select a new special card is received. For example, the following types of special cards are considered in the process: system message cards, gift cards, and boosted cards. In various embodiments, other types of cards and/or any subset of these cards may be considered “special.” Additionally, the order in which these types of special cards are considered may be different in various embodiments.

At state 1002, the system determines whether a system message card is available. If so, then at state 1003 the system message card is selected and provided for display. System message cards may include advertisements, reminders to users to update profile information, and the like. In an embodiment, the system only causes the display of system message cards that have not yet been viewed by the user. In an embodiment, where multiple system message cards are available for viewing, the oldest system message card is selected first. Optionally, system messages are displayed in a popup or separate part of the user interface rather than as a card.

Optionally, a demonstration/learning mode is provided to a new user or to an existing user when he first accesses the system that may cause the processes disclosed herein to behave differently, for example, based on how long a user has been on the site and/or how much they have added content to their profile. For example, the quality of some or all of the content on the site may be restricted and/or the quality degraded.

At state 1004, the system determines whether there are any gift cards available for the current user. If so, then at state 1005 the most recent gift card is selected and provided for display. Gift cards may arise when one user wishes to provide a gift to another user. A gift may be a real gift, a gift of currency, a gift of virtual currency such as system credits or a membership upgrade, a virtual gift such as an image or badge, music, or the like.

At state 1006, the system determines whether there are any boosted cards available for the current user. If so, then at state 1007 the most recently boosted card is displayed. Boosting is a process by which a user may increase the visibility of the user's card by having the card displayed earlier in other users' card-feeds. An amount of system credits or currency may be charged for a boost, and boosts may be limited in other ways, such as by membership levels. In an embodiment, boosts are limited by time and/or users. For example, a boost may have a duration limiting how long the user's card remains boosted, and it may have a boost target group indicating which users may see the boosted cards early in their card-feeds.

As noted above, the system application may provide a mechanism called “boosting”, enabling a user to make their profile, card, and/or contact listing more prominent to other users. For example, if a user A boosts his card (card A), then in some other users' card-feeds, card A might be shown earlier than it otherwise might have been shown. The other users for who card A will be boosted may be identified by the application as a boost target group. A user may, for example, select/specify how many other users will be in his boost target group by selecting a geographic range (e.g., 10 miles from my home address, 20 miles from my work address, 50 miles from my current location, or a specified neighborhood or city, such as Los Angeles), and/or a total number of users in the boost target group.

Optionally, the system may then randomly or non-randomly choose from users that match the criteria of the user who requested the boost, which users may be included in the boost target group. Optionally, the system may determine and select users that have user A in their user relevant universe to include in user A's boost target group. Optionally, the system is configured so that users are placed in the boost target group based on having a certain status, such as having a state of “online state.” Optionally, if card A is boosted and user B is in user A's boost target group, then card A may remain boosted and user B may remain in user A's boost target group until card A has been shown to user B or until the end of the boost duration.

The system may maintain a maximum length of time (a boost duration) between when a user B is included in another user A's boost target group and the user B is automatically excluded again for user A's boost target group. The boost duration may be infinite or may be for a limited period of time. Optionally, a user B only remains in the boost target group for the entire boost duration if boosted card A has not been shown to user B before the end of the boost duration. If boosted card A has been shown to user B before the end of the boost duration, then user B may be taken out of user A's boost target group at the time card A was shown.

As noted above, when users click the boost button, it may make their card more prominent and/or it might be shown to other users sooner than it otherwise would have been shown. Optionally, boosts may be purchased by the user by making a payment for a desired amount of boosts or using system credits. Optionally, a user may be provided with one or more boosts for free, to enable the user to try out and gain experience with the boost function. There are several optional implementations.

For example, a boost may be shown/affect the order of display of the user's card/contact/profile to everybody in the user relevant universe, or everybody who is online from the user relevant universe. Optionally, the effect of a boost on is limited to users within a certain geographic radius of the user or to users that have a certain characteristic specified by the user. Optionally, the effect of a boost, with respect to the effect on the display of the user's card/contact/profile is limited to a certain amount of users, which may for example be chosen randomly by the system.

If there are no system message cards, gift cards, or boosted cards, then at state 1008 the system indicates that no special cards are present, so that process may proceed to consider other types of cards such as active cards and general cards.

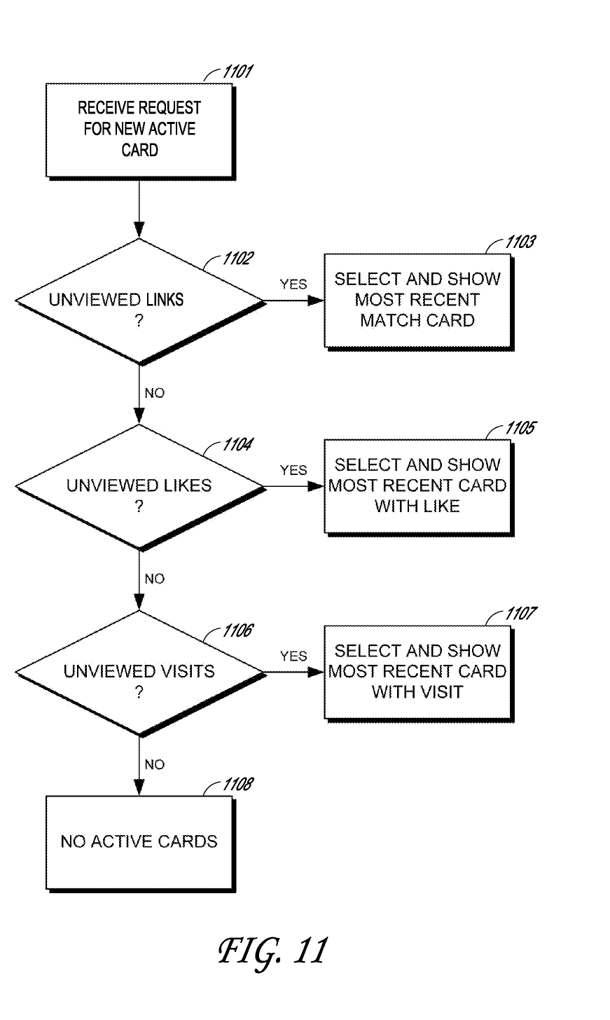

FIG. 11 is a flowchart of a process of selecting an active card, as used in an embodiment. The process may be performed by social interaction system 101 of FIG. 1, for example. The process may be performed at states 904 and 905 of FIG. 9, for example. In various embodiments, additional states may be included, some states may be removed, and/or states may be connected or arranged differently from what is shown.

At state 1101 a request to select a new active card is received. In this example, the following types of active cards are considered in this process: links, likes, and visits, corresponding to the respective types of activities stored in activities data 607 of FIG. 6. In various embodiments, other types of cards and/or any subset of these cards may be considered “active.” Additionally, the order in which these types of active cards are considered may be different in various embodiments.

At state 1102, the system determines whether there are any cards with unviewed link activity. If so, then at state 1103 the active card with the most recent unviewed link activity is selected and provided for display. The card with the most recent unviewed link activity may be determined based on link timestamp 610. For example, if user A liked user B and user B liked user A back, then a link between user A and B is created and card B will become an active card with unviewed link activity for user A. As soon as card B is shown to user A as being an active card with unviewed link activity, it may no longer be considered an unviewed link activity and card B may no longer be considered an active card. Active cards with unviewed likes or unviewed visits may optionally be treated in a similar way.

At state 1104, the system determines whether there are any cards with an unviewed “like.” If so, then at state 1105 the card with the most recent unviewed “like” is selected and provided for display. The card with the most recent unviewed “like” may be determined based on “like” timestamp 609.

At state 1106, the system determines whether there are any cards with an unviewed visit. If so, then at state 1107 the card with the most recent unviewed visit is selected and provided for display. The card with the most recent unviewed visit may be determined based on visit timestamp 608.

If there are no active cards, then at state 1108 the system indicates that no active cards are present, so that it may proceed to consider other types of cards such as general cards.

In an embodiment, cards are included once in a user's card-feed and once they are provided for display to a user, they are not displayed again to the user in the card-feed (unless the user specifically requests that the card be displayed again). Optionally, cards may be repeated in a card-feed. A decision as to whether to display a card multiple times may be based at least in part on activity on the card. For example, a card may be displayed once with no activity, and then displayed in response to a visit by another user, then displayed in response to a “like” by a user, and then again displayed in response to a link with another user. It is also possible that when any visit, like, link or other activity happens with respect to a card, that card is not repeated in the card-feed but instead is moved. In this situation, when a card A was shown before as a general card, and the user B activates the forward control, card A is displayed again as an active card with an unviewed like, the card A is moved to the end of the card-feed as the latest card shown. If user B then clicks the reverse control to view the cards that were shown in the past to him, card A might not be included a second time in the card-feed.

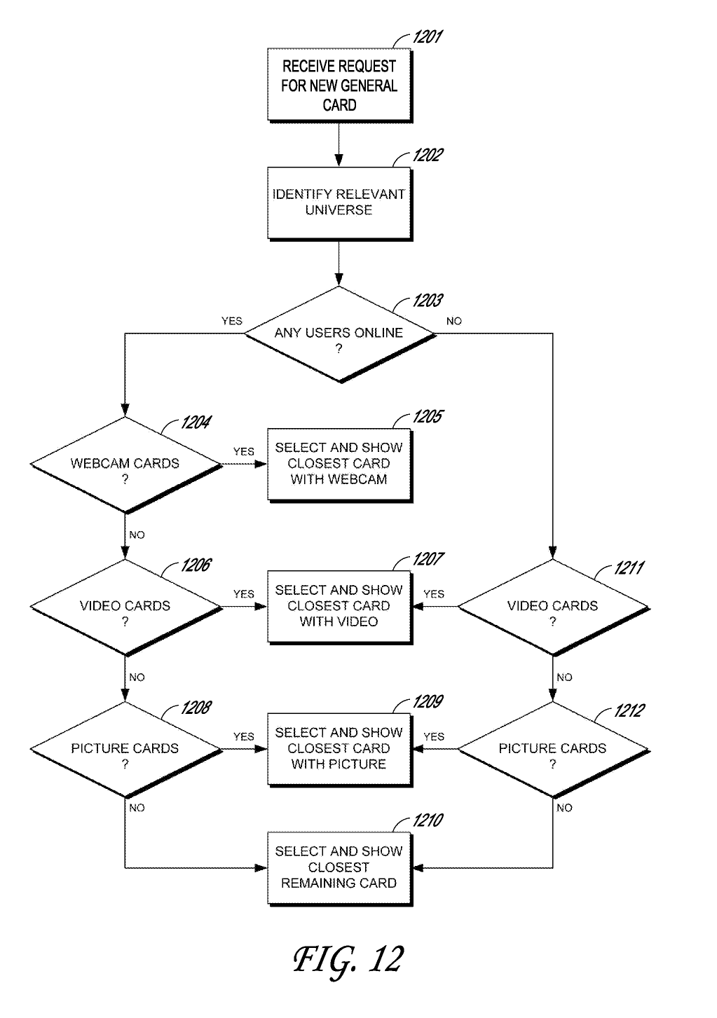

FIG. 12 is a flowchart of a process of selecting a general card, as used in an embodiment. The process may be performed by social interaction system 101 of FIG. 1, for example. The process may be performed at state 906 of FIG. 9, for example. In various embodiments, additional states may be included, some states may be removed, and/or states may be connected or arranged differently from what is shown.

At state 1201 a request to select a new general card is received. Five main considerations are incorporated into the process: whether displaying users are online, whether their cards include live webcam streams, whether their cards include videos, and whether their cards include pictures and how closely the displaying user and the viewing user are physically located to each other. In various embodiments, different factors may be considered. Additionally, the order in which these factors are considered may be different in various embodiments.

At state 1202, the system identifies the relevant (or likely relevant) universe of potential users whose cards may be displayed to the viewing user (sometimes referred to herein as the user relevant universe), which may be a subset of the profiles in the user database. The universe may be limited in various ways defined by the system and/or the requesting user. For example, the system may restrict the relevant universe of cards to those that have not yet been viewed by the user. The universe of cards may further be restricted based on some or all of the following user search preferences indicating the characteristics the user is looking for with respect to people to meet or learn about: geolocation (to ensure that only cards of nearby users are shown, such as those within 100 miles of the user), minimum and maximum age, gender preference, sexual orientation preference, religion, profession, education, personality type, marital status, family status (e.g., whether the user is interested in potential matches with users with children), personality, location preference, only profiles that have email and/or SMS addresses verified by the system, user photographs, user videos, and so on. Optionally, different criteria may be used to restrict the relevant universe for a specific user.

At state 1203, the system determines whether any of the users in the identified relevant universe are currently online. In an embodiment, the system preferentially selects cards of online users over cards of offline users (e.g., will first select online users to include in the feed, and when there are no more online users to include in the feed, will then select offline users to include in the feed). In an alternate embodiment, the system treats online and offline users identically and/or considers additional factors such as the device through which the user is connected or other selection criteria discussed herein.

If there are any online users, then the system proceeds to select an online user to add to the card-feed. Users with live webcam streams are selected first at states 1204 and 1205. Optionally, if there are multiple online users with a live webcam stream in the relevant universe, then the online user whose location is closest to the location of the viewing user is selected and shown. If there are no online users with live webcam streams, then optionally the closest user without live webcam streams, but with video profiles is selected and shown at states 1206 and 1207, and in the absence of any such user, the closest online user without live webcam streams or video profiles, but with picture profiles is selected and shown at states 1208 and 1209. If none of these users are present, then at state 1210 the closest online user without live webcam streams, video profiles or profile pictures may be selected.

If there are no online users, then the system proceeds to select an offline user to add to the card-feed. Optionally, webcam cards may be excluded from the card feed or skipped because presumably offline users do not have a live webcam stream. The system may first attempt to identify offline users with video profiles and will select and show the user closest to the viewing user at states 1206 and 1207, and in the absence of offline users with video profiles, the closest offline user without video profiles but with picture profiles is selected and shown at states 1208 and 1209. If none of these users are present either, then at state 1210 the closest offline user with no video profile or profile picture may be selected.

Optionally, only cards with pictures, cards with video, or cards with webcam streams may be selected for the card-feed, possibly depending on the requesting user's preferences. Also, in some situations the aforementioned algorithm may fail to select a card (e.g., because a satisfactory user is not identified), in which case the user may be notified to wait and/or prompted to change the card-feed search parameters.

The card-feed may optionally be implemented as a linked-list, providing significant flexibility to reorder the cards around and also enabling storing a large or unlimited history of cards.

Once there are no more cards left at a given time to present to the user, as determined by the card-feed algorithm, (e.g., if the system determines that all current relevant profiles have been presented to the user, according to the user's current filter criteria), the system front-end may periodically query the system back-end database to determine if anything relevant has changed which may allow one or more cards to be shown. For example, the user may change the filter criteria or wait for another user (e.g., a new user) who fits the original criteria to upload their profile into the system.

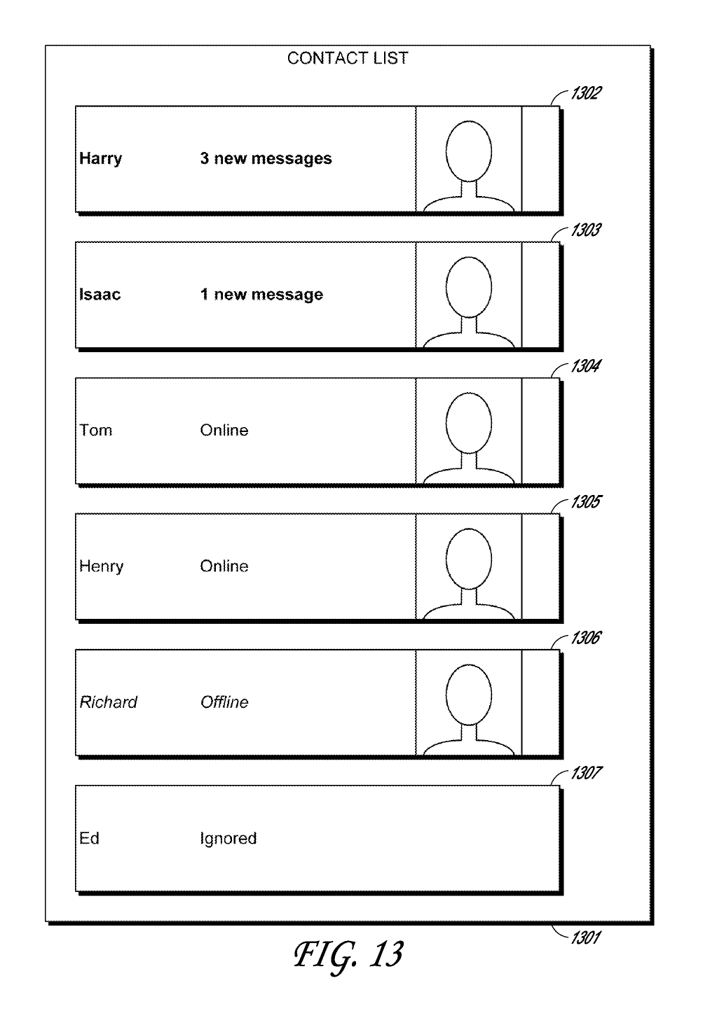

FIG. 13 depicts an example user interface showing a contact list, as used in an embodiment. The contact list may be shown in user interface element 302 of FIG. 3, for example. The interface may be presented in various formats compatible with various user devices, such as a web page, Flash content, XML, mobile interface, desktop application, and so on. In various embodiments, the elements of the interface may be differently arranged, additional elements may be included, and elements may be omitted.

Contact list 1301 may include listings of contacts 1302-1307. The contact list may be organized according to particular rules, optionally defined or customized in whole or in part by the user viewing the contact list. For example, in contact list 1301, users with unread messages 1302 and 1303 are listed first, followed by online users 1304 and 1305, offline user 1306, and ignored user 1307. Other criteria may be used to order the contact list or the order of these abovementioned criteria may be altered.

A user may ignore a contact by, for example, selecting the contact in the contact list and selecting an ignore control. If a contact is ignored, that contact may, for example, appear greyed out (to indicate it is ignored), and optionally any activity from the ignored user or change in state with respect to the ignored user (e.g., online, offline, etc.) is not shown to the user. An ignored contact may be un-ignored by, for example, clicking it in the contact list and selecting an un-ignore control. Optionally, one or more messages that were sent while the contact was ignored may be provided for display to the user after the contact was un-ignored by the user.

Each of the aforementioned sections may be organized by timestamp of relevant events (e.g., the user who most recently send a message may be listed at the top of the users with unread messages). The foregoing ordering may be altered or redefined by the user. The list may further identify the status of users by highlighting, graphically indicating, and/or textually indicating the status. Where the list runs beyond the length of the window in which it is displayed, a scroll bar or other appropriate interface element may be included to allow further navigation of the contact list.

The list may further include interface elements enabling the viewing user to interact with the contacts on the list. Example actions may include one or more of the following: viewing a contact's card, chatting with the contact, liking the contact, ignoring the contact, un-ignoring the contact, removing the contact from the contact list, and so on.

For example, the system may present a contact list, as similarly discussed above, the contact list may include visual representations of contacts in the contact list. These visual representations may be designated “contact list items.” The visual representations may include, for example, the picture and/or name of the contact. Contact list items may include other information, such as a status, a video, an indicator of a card type, and so on. The status may be indicated by a text indicator and/or a graphical icon, as well as an identifier associated with the contact.

A contact-list algorithm may automatically rank and organize contacts in the contact list according to rank, so that contacts that are estimated to be relatively more or the most interesting (higher ranked contacts) are on top or towards that top of the list and easily accessible for the user, while relatively lower ranked contacts are presented lower in the contact list or not displayed at all. This may minimize the time the user has to spend scrolling through the potentially numerous different contacts to find the contact he is looking for. Optionally, the contact list may be otherwise sorted (e.g., alphabetically according to the contact name, most recent to least recent, least recent to most recent, etc.).

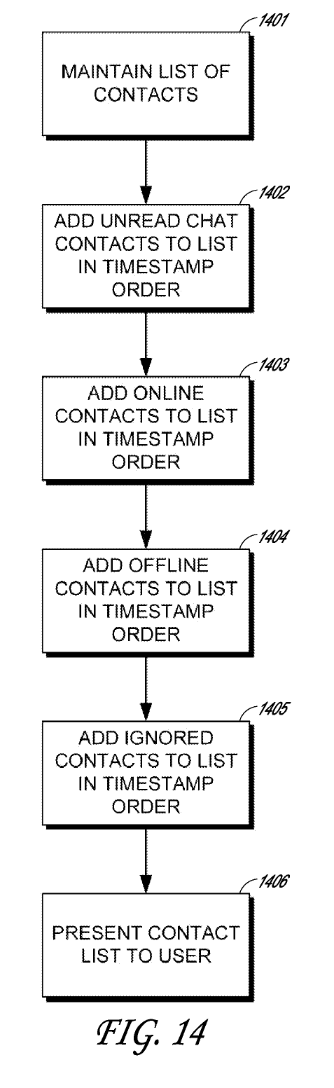

FIG. 14 is a flowchart of an example process of constructing a contact list, as used in an embodiment. The process may be performed by social interaction system 101 of FIG. 1 and/or by user devices 103 in accordance with executable code provided by the social interaction system or any other system, for example. In an embodiment, optionally some or all of the process of FIG. 14 is performed by code (e.g., scripting code, such as JavaScript code), on a user device. In various embodiments, additional states may be included, some states may be removed, and/or states may be connected or arranged differently from what is shown. This process may take into account several aspects, including but not limited to the last time messages where sent between the user and another user, whether these messages were already viewed by the user, whether users are online, offline, or ignored. As will be discussed, the process may optionally automatically organize contacts in the contact list, so that the contacts that are estimated to be most interesting are at the beginning of the list and easily accessible to the user. This may reduce or minimize the time the user has to spend scrolling through the various different contacts to find the contact she is looking for.

At state 1401, a list of contacts is maintained in association with a user. The list of contacts may be maintained as contact data 507 of FIG. 5, for example. At various times, the list of contacts may then be processed to generate a user interface listing. This may occur, for example, upon initial loading of an interface such as that shown in FIG. 3. It may also occur upon detection of a change to the state of one or more of the contacts of the user. For example, when the algorithm is activated, the process may start by attempting to fill position 1 (the top most position) in the contact list and in parallel or once successful it may move down and fill the next position (e.g., position 2), etc.

In an embodiment, a pre-sorted list of contacts is maintained, so that the sorting process described herein need not be performed every time the contact list is requested. In an embodiment, where the contact list is to be updated due to a change in state of one or more contacts on the list, optionally the system only updates the portions of the list that have indicated changes. The contacts may be listed in order of when a contact became a contact of the user, or in reverse order of when a contact became a contact (e.g., as determined from timestamps associated with contacts indicating when a contact became a contact).

The contact-list algorithm may optionally be activated each time the system detects one of the user's contacts changing its contact-state, and/or the contact list may be activated periodically, and/or the contact list may be activated when the user logs in or accesses the contact list, and/or in response to a user activation of a refresh control (e.g., a contact list refresh control). When the algorithm is activated, it may optionally start by trying to fill position 1 in the contact list and in parallel or once successful it may move down and fill position 2, etc.

At state 1402, the system adds contacts with unread chat status to the list for display. These are contacts that have not been ignored and have sent a chat message to the viewing user that has not been shown yet to the viewing user. The unread chat status contacts may be added in timestamp order so that those with the most recently sent unread chat messages are listed first, in most recent to less recent order, or the unread chat messages may be listed in less recent to most recent order. This ordering may be determined based on unread chat state timestamp 510 of FIG. 5.

At state 1403, the system adds contacts with online status to the list for display. These are online contacts that have not been ignored and from whom there are no unread chat messages. The online status contacts may be added in timestamp order (e.g., more recent to less recent or less recent to more recent). For example, those who most recently logged on may be listed first (or may be listed last). This ordering may be determined based on online state timestamp 511 of FIG. 5.

At state 1404, the system adds contacts with offline status to the list for display. These are offline contacts that have not been ignored and from whom there are no unread chat messages. The offline status contacts may be added in timestamp order so that those who most recently logged off are listed first (or last). This ordering may be determined based on offline state timestamp 511 of FIG. 5.

At state 1405, the system adds contacts with ignored status to the list for display. These are contacts that have been ignored by the viewing user. The ignored status contacts may be added in timestamp order so that those who most recently were added to the list of contacts are listed first (or last). Alternately, the contacts may be ordered based on when they were indicated as ignored. This ordering may be determined based on ignored state timestamp 512 of FIG. 5 (e.g., less recent to more recent, or more recent to less recent) or contact timestamp 513 of FIG. 5.

At state 1406, the contact list is presented to the user, by being constructed and transmitted via a network to a user device or by being displayed directly on the user's display.

Many variations to the example algorithm may be utilized. The user may manually add a second user to the contact list by activating an “add to contact list” control, which may be displayed on or in association with the second user's profile card. Optionally, when the user likes a second user, the second user may automatically be added to the contact list. By way of further example, the contacts in online and offline state may be sorted based on different criteria than when the respective contact went online or offline. For example, contacts may be sorted by at least in part, when the contacts sent or received chats (and/or other communications) to or from the user. The contacts in an “ignored” state may be sorted, for example, based on when they were ignored (e.g., most recent to less recent, or less recent to most recent), instead of when they became contacts. Additional different states and/or different timestamps may be created and used in the algorithm, or fewer different contact states may be used to sort the contact list. For example, contacts may just be sorted alphabetically. Optionally, a search function is integrated to find contacts. Any combination of these aspects is possible.

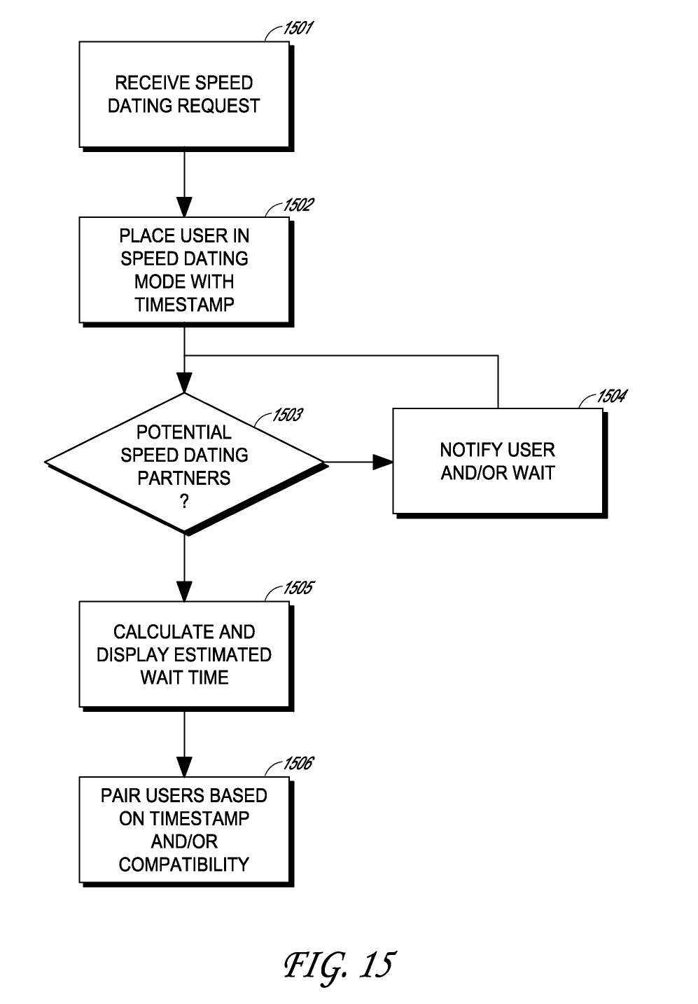

FIG. 15 is a flowchart of a process of entering a speed-dating activity, as used in an embodiment. The process may be performed by social interaction system 101 of FIG. 1. In various embodiments, additional states may be included, some states may be removed, and/or states may be connected or arranged differently from what is shown.

At state 1501, the system receives a request from a user to participate in a speed-dating activity. The system then determines an appropriate universe of potential speed-dating partners. The universe may be limited by various factors. For example, only users who are not contacts of the user may be considered as potential speed-dating partners. Optionally, only users who are not ignored by the user may be considered.

For example, the system may identify a group of users that meets a number of criteria, optionally including some or all of the following: 1) they are part of user A's user relevant universe 2) they are in speed-dating mode and/or 3) they have never in the past speed-dated with user A.

When the user enters speed-dating mode a timestamp may be associated with that user. The speed-dating timestamp may enable the system to track the moment the user enabled speed-dating mode and may be used to decide where he is position in a waiting list to start speed-dating. This speed-dating timestamp may be a relative timestamp (such as an amount of time elapsed since the user entered speed-dating mode), indicate whether the user entered speed-dating mode before or after another user entered speed-dating mode, or an absolute timestamp that keeps track of the actual time the user entered speed-dating mode, or otherwise enable tracking when the user entered speed-dating mode. When the user starts an actual speed-date, the speed-dating timestamp may be optionally removed.

The abovementioned process is represented in state 1502: the user is placed into a speed-dating mode, and a timestamp is associated with the user to record the user's entry into the speed-dating activity. The timestamp may be used to determine when it is the user's turn for a speed date. For example, the system may select the user who has waited the longest for the next speed date.

If, at state 1503, the system determines that there are no potential speed-dating partners for the user, then at state 1504 the user is notified (enabling the user to change the user specified criteria), and/or the system waits for potential partners to arrive.

At state 1505, the system calculates and displays an estimated wait time for the user. The wait time may be based on the number of currently ongoing speed dates and/or the number of other users waiting for a speed date. In case of an imbalance of men and women, for example with more men than women wanting to speed-date with someone of the opposite gender, men may have to wait longer than women for their next speed-date. If there are more women than men waiting to speed-date with someone of the opposite gender, then women may have to wait longer than men for their next speed-date.

The system then pairs users for speed dates at state 1506 when an available pairing is possible. The pairing may be based on timestamps as described above. It may additionally or alternatively be based on a computation of compatibility between the users. For example, the geolocation of the users may be considered in pairings.

Optionally, a combination of different criteria is used in determining pairings. The criteria may include, for example, how long participating users have been waiting and how interesting users are considered for each other. For example, optionally first users get moved by the system from the speed-dating waiting queue to a pool of users that are ready to start the speed-dating session, wherein users may be moved to this pool together with somebody from their speed-dating universe. The allocation to this pool may, for example, be based at least in part on who has been waiting the longest. Optionally, a fixed time before the start of the speed-date, (e.g., 10 seconds), this pool is frozen and other users are not added to the pool during this time. The system may then create a final pairing of users who are estimated to be relatively the most optimal partners from this pool, based on other aspects, such as, for example, geo-location, interests, etc. This would prevent that somebody may be waiting indefinitely for a speed-date, but at the same time creates an opportunity to maximize the chance that the user meets somebody interesting on the speed-date.

Optionally, a filter limitation may be included so that users are only paired with other users that they are not yet contacts with. Optionally, a filter limitation may be included such that users are not paired with contacts that user has previously provided an ignore indication for. Optionally, in addition or instead, the system determines if users have visited, liked or linked with each other through the normal card-feed system and if so, first pairs up respective links, then likes, and then visits. Other factors that may be taken into account include one or more of the following: membership level, geo-location, common interests, common friends on one or more social networks, other user specified criteria discussed herein, etc. Thus, optionally, it is not the user with the longest wait time duration that is chosen as the next pair member, but rather the user that is considered by the system the most likely to be interesting to the other user.

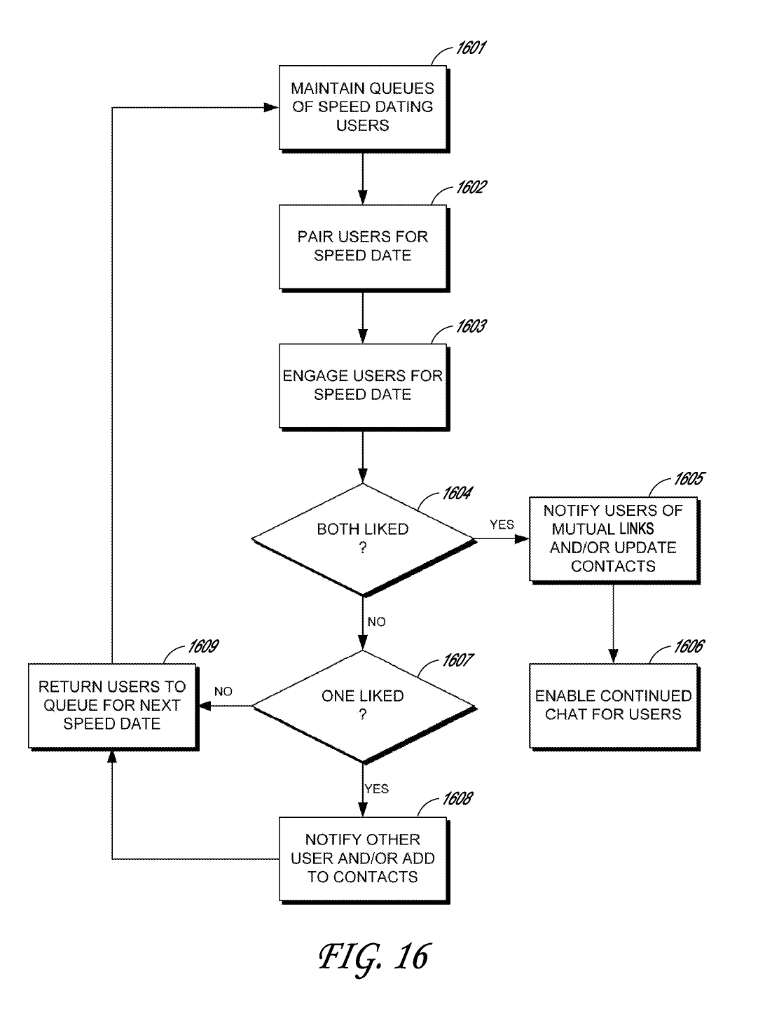

FIG. 16 is a flowchart of an example process of operating a speed date, as used in an embodiment. The process may be performed by social interaction system 101 of FIG. 1. Multiple instances of the process may be performed in parallel, enabling simultaneous speed dates to occur. In various embodiments, additional states may be included, some states may be removed, and/or states may be connected or arranged differently from what is shown.

At state 1601, queues of users waiting for speed dates are maintained. At state 1602, users are paired for speed dates, as described above with respect to state 1506 of FIG. 15. The users are then engaged on a speed date at state 1603. The speed date may be conducted by video chat, audio chat, text chat, or the like. In an embodiment, the speed date is limited to a time period set by users and/or the system. In an embodiment, the time limit is 1.5 minutes. The time limit may be calibrated based on past performance analysis to balance interests of efficiency in performing multiple speed dates, and providing sufficient time for a full evaluation of the dating partner to be made.

During the speed-dating period, both users are provided with an option to “like” the other user to indicate that they are interested in the other user. At state 1604, the system determines whether both users have “liked” the other. This determination may be made at the end of the allotted time or at the time that the second user indicates the “like.” If both users indicated a “like,” then at state 1605 the users are notified of the mutual link, possibly with an alert sound, message, graphic, and/or other notification. Additionally, the users' contact lists may be updated with each other, and a “link” activity may be recorded as described above. Additionally, at state 1606, the users may be permitted to continue to chat beyond the allotted time limit. In an embodiment, the users are permitted to chat indefinitely. In an alternate embodiment, the users are permitted to chat for a specified amount of additional time. The amount of additional time may be determined by membership level, payment of system credits, or the like.

If the system determines, at state 1607, that only one of the users “liked” the other, then the system may perform a number of operations. The user who was “liked” may be notified subsequent to the speed date, and optionally invited to “like” or otherwise interact with the “liking” user. The notification may be made after the conclusion of all speed dates in a speed-dating session, in an embodiment. Additionally or alternatively, the contact list of the user who “liked” the other may be updated to include that “liked” user at state 1608.

At state 1609, the users may be given an option to proceed to another speed date with another user. The option may be presented as a countdown clock.

If, in a pairing, only one user liked the other one, the pair may still be provided a corresponding notification in their respective feeds (optionally, only after the speed-dating session, optionally using the speed dating session). This enables the user that did not provide the “like” indication to reconsider and change her mind in view of the other user's like indication, and to provide a like indication with respect to the other user, even after the speed date is completed. However, optionally, in this case the system will inhibit communication between the users during the session (e.g., they will not be permitted to talk or chat to each other via the system). At that point, at state 1609, both users will be returned to the speed-dating queue where they can wait to be paired up with a next user for a new speed-date. Alternatively, at state 1609 the users may also be presented by the system with a user interface that asks them if they want to continue speed-dating, with a countdown time (e.g., 20 seconds) in which they both need to respond. If they do not click on a control indicating they want to continue the session, or click on a control indicating that they do not want to continue the session, they will be taken out of the queue. If a user responds to the query with an indication that he wants to continue speed-dating session with a next user (e.g., by clicking a “yes” control), the system receives the response. If the system determines that another speed-date is waiting, the user is provided by the system with a countdown window (e.g., 10 seconds). The user that was waiting for a speed-date and is paired up with the first user will also be provided with a countdown window (e.g., 10 seconds). If there are no potential speed-dating partners available for the first user, then the user is presented by the system with the last profile the user was looking at in the card-feed, and the estimated countdown to the next speed-date is indicated.

The number of speed dates may be limited by the system, optionally based on system credits and/or membership level. For example, optionally non-premium members (e.g., users that do not pay a membership fee or that pay a relatively lower level membership fee) may be limited by the system to participating in a specified number of speed-dates or a specified number of speed-dates for a specified period of time, such as 1 speed-date per day or 15 speed dates per month. While waiting for the next speed-date, users may continue browsing the dating site. Optionally, the system may cause an estimated wait time to be displayed on or adjacent to the feed (e.g., on the right bottom side of the feed or elsewhere).

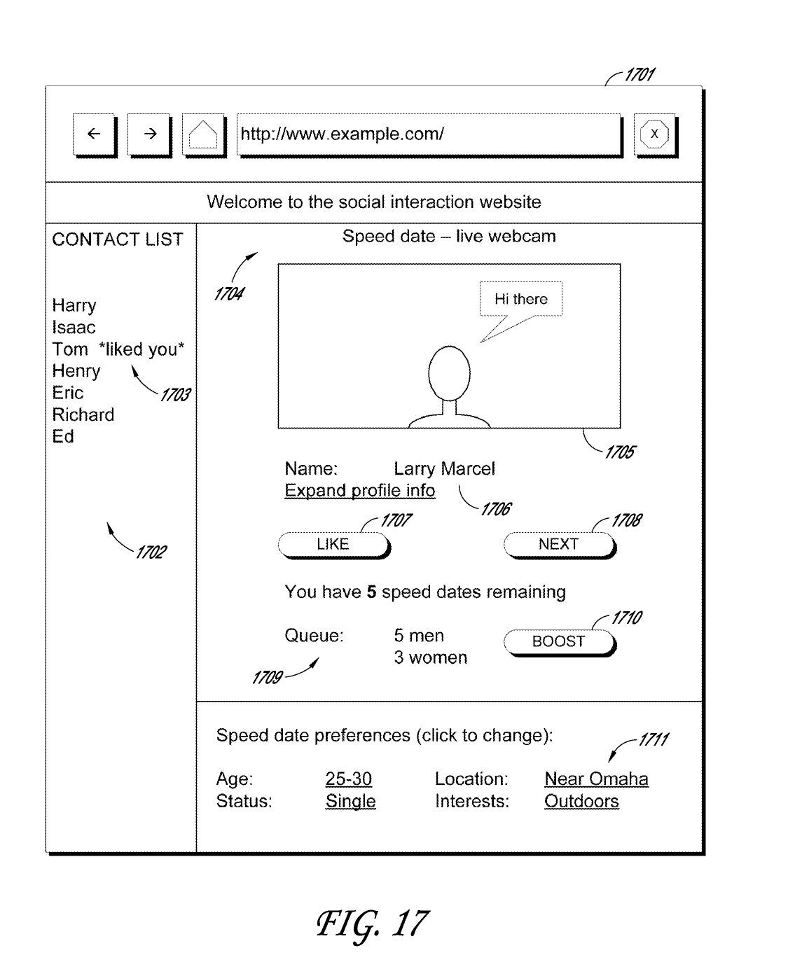

FIG. 17 is an example user interface during a speed-dating activity, as used in an embodiment. The interface may be presented in various formats compatible with various user devices, such as a web page, Flash content, XML, mobile interface, desktop application, and so on. In various embodiments, the elements of the interface may be differently arranged, additional elements may be included, and elements may be omitted.

Interface 1701 may include contact list 1702, which may include the user's contacts as shown in element 302 of FIG. 2. Alternately, the contact list 1702 may be based on the user's past or future speed dates. The contact list may indicate users who indicated a “like” for the current user, such as indication 1703.

Speed-dating pane 1704 displays a current speed date in progress. It may include webcam display 1705 where the speed date is conducted by webcam. Alternate displays may be shown where the speed date is conducted by text chat or audio. Profile information 1706 may also be included in pane 1704. Additional information about the speed date, such as the amount of time remaining, may further be displayed on the interface.

“Like” button 1707 enables the viewing user to “like” the user on the speed date. As described above, a link event may occur when both users select the “like” button. In an embodiment, when the “like” button is selected, the “like” event is kept secret if the other user does not select the “like” button. In an embodiment, the secret is optionally kept until the end of the speed date or until the end of the speed-dating session. If both users like each other during the speed-dating session, the system may enable the users to continue communicating (e.g., talking, text chatting, video conferencing) with each other after the date-duration is finished.

“Next” button 1708 may be provided to enable the user to terminate the current speed date. It may be used, for example, if the user finds the speed date particularly disagreeable or fruitless. In an embodiment, where a user selects the “Next” button during a speed date, the other user on the speed date is optionally refunded for any credits or speed date quota used.

A queue of other waiting speed daters is maintained, and information about the queues may be displayed at interface element 1709. This information may be used to determine how long the user would have to wait for the next speed date. “Boost” button 1710 may be provided to enable the user to advance in the queue, possibly in exchange for system credits. In an embodiment, interface elements 1709 and 1710 are displayed on a speed date waiting interface, rather than on the interface of a speed date in progress.

A user may also select preferences for the types of desired speed-dating partners, using interface element 1711. This may allow for the speed-dating partner selection algorithm to narrow the potential universe of speed-dating partners and improve the likelihood that the user will be matched with a desirable partner.

The embodiments described herein, including the application and user interfaces, may be adapted to provide a new and innovative way to search for items, such as a real estate or media.

For example, a card in the card-feed may include an image (e.g., a photograph or drawing) of an item, such as real estate (e.g., a house or other structure and/or a lot) available on the market instead of, or in addition to, profile pictures of other users. In addition to or instead of the image, a card may include details about a respective item of real estate and optionally may include a small map with similar matches in the neighborhood.

Such an embodiment may include a user interface displaying one (or more) main images (e.g., a photograph or drawing) of an item of real estate (sometimes referred to herein as a property), with the system rotating through other uploaded images in response to user requests and/or other appropriate triggers as similarly described elsewhere herein. The card-feed may be filtered by the system in numerous ways. For example, filtering may be performed based on user preferences and/or information. By way of illustration, the filtering may be performed based on some or all of the following criteria: location (e.g., real estate properties near a user specified location (e.g., within a user specified zip code, city limits, boundary, etc.)), price range (e.g., bounded by a minimum and/or maximum prices), features the real estate properties offer (e.g. number of bedrooms, proximity to a geographic feature (e.g., a forest, lake, beach, ski slope), etc.), and/or filtering by property type (e.g., single family house, condominiums, apartment, or office). Optionally, the system may rank the search results and may indicate property is the best matching property for the user based at least in part on the user preferences.

The system may further provide user accessible controls enabling a user to indicate that the user “likes” a particular property. Where a user selects this and/or other options, an image and/or other identifier associated with the corresponding property may be provided for display (e.g., in a sidebar), providing a convenient list of the user's favorite properties. The list may have features similar to those discussed with respect to the contact list as described above.

The chat system as described with respect to the dating application may be similarly applied to the real estate application. For example, a user may indicate that she wants to chat with a sales person and/or real estate owner of the property whose card she is currently viewing, and the system will then facilitate the chat session.

Further, a sales person and/or property owner may, via the system, “boost” their property to enhance its position in the card-feed or otherwise enhance the presentation of the property to the user, to thereby reach more potential buyers or better reach potential buyers, using systems and processes as similarly described above.

The embodiments described herein, including the application and user interfaces, may be also applied to the media industry, for example to enable users to watch television broadcasts or movies online.

For example, one or more streaming video channels may be included instead of, or in addition to, the profile images. The interface may be configured to enable the user to skip through or randomly select the channels, as one might do with a remote on a traditional television, to thereby view video channels and to select a channel the user finds interesting.

The user interface may include a list of interesting channels (e.g., in a sidebar), selected by the user and/or the system based on factors such as channels the user liked. The user may navigate to and view a given listed channel by clicking on the channel or on a corresponding control.

A message stream linked to the current playing channel may replace or supplement the user chat. For example, the system may provide for display or otherwise provide a stream of messages from third party social media providers (such as microblogger sites) gathered by the system. The system may enable the user to post directly to other social media providers from within the application, for example by receiving messages through a chat-like interface and posting those messages to appropriate social media sites.

In an example embodiment, the application may include a credit system or other payment system enabling the user to purchase the right (e.g., using system credits, a credit card, a debit account, etc.) to watch premium channels (e.g., on a pay-per-view basis or on a subscription basis). In an embodiment, network content providers may be able to boost content, such as video, so that they will have preferred placement and will be more likely to be viewed by users.

The application may also be configured to sort the channel list for the user, for example ranking and listing channels the user might be interested in first (e.g., as determined by the user's preferences and/or media likes).

Instead of, or in addition to, using a keyboard to navigate through the channels, the system may be configured to respond to more intuitive interaction user interface, such as a remote control or a gesture based navigation controls. This feature may be applied, by way of example and not limitation, to large media screens (e.g., large television screens), tablet devices, mobile phones, 3D displays, projection systems, and so on. Remote-controlled, gesture-based, and/or other forms of interaction with the system may be applied to any of the embodiments described herein, such as the dating and real estate applications.

Embodiments described herein may also be applied to other industries, including but not limited to the recruiting field, the research information field, field of industry associations or groupings providing information regarding their members to potential clients, travel industry, retail industry, etc.

Thus, certain systems and processes described herein may optionally offer one or more of the following features and advantages:

In embodiments where the user needs to move forward in the card feed to learn who visited, liked, and/or linked with the user, the user may be very motivated and eager to frequently view the next profile card, resulting in longer and more frequent use of the system; By providing alert notifications to the user when new visits, likes, links, chats, and/or other activities by other users related to the user (where the notifications optionally do not identify the other users that initiated the activity), the user may again be very motivated and eager to access the system to see who the activity was from, resulting in longer and more frequent use of the system.

In embodiments where a user can both view profile information regarding other users and also communicate with other users (for example liking them or sending them a chat message) on the same user interface screen, the user has a very user-friendly user-interface, which prevents the need to navigate around to different sections of a website to perform different viewing and communication activities.

Because a given user's actions may trigger many events (e.g., visits, likes, links, gifts, etc.) on other users feeds, the other users may be curious to learn more regarding the events, which may in turn trigger yet more events;

Optionally, the system can be configured such that a user may preview one or more profiles ahead in the card-feed, while still viewing a current profile card.

Low threshold techniques for users communicate with other users may be provided (e.g., the like function makes the step of getting in touch with another user very easy to take, as compared to requiring the user to write a message to someone they are interested in, where a user would have to consider the right words to use in the message and work up the courage to send the user-drafted message to make contact with another user). This may encourage users to more quickly get in touch with other users.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, states, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which states, elements or functions may be deleted, executed out of order from that shown or discussed, including substantially concurrently or in reverse order, depending on the functionality involved, as would be understood by those skilled in the art.

The methods and tasks described herein may be performed and fully automated by a computer system. The computer system may, in some cases, include multiple distinct computers or computing devices (for example, physical servers, workstations, storage arrays, and so forth) that electronically communicate and interoperate over a network to perform the described functions. Each such computing device typically includes a processor (or multiple processors) that executes program instructions or modules stored in a memory or other computer-readable storage medium. Where the system includes multiple computing devices, these devices may, but need not, be co-located. The results of the disclosed methods and tasks may be persistently stored by transforming physical storage devices, such as solid state memory chips and/or magnetic disks, into a different state.

It is noted that the storage of various different types of information and the hosting of various software and applications may be provided in-house, by the company offering the services (e.g., the online-dating services), and/or hosting may be outsourced to one or more external service providers, which may reduce the maintenance burden and increase scalability. A content delivery network (CDN) may be used in addition or instead (e.g., to speed up the global or large scale delivery of static files that infrequently change, such as application assets and media).

The example interfaces described herein may optionally be structured as data, such as HTML content, and then transmitted to users via one or more wired or wireless network connections, such as the Internet. In addition or instead, interfaces may also be generated on an end user's computing device (e.g., via a desktop application or mobile phone application).

While certain ranking and sorting criteria and processes are described herein (e.g., with respect to user profiles, contacts, etc.), other ranking and sorting criteria may be used instead or in addition.

All of the methods and processes described above may be embodied in, and fully automated via, software code modules executed by one or more general purpose computers. The code modules may be stored in any type of computer-readable medium or other computer storage device. Some or all of the methods may alternatively be embodied in specialized computer hardware. The results of the disclosed methods may be stored in any type of computer data repository, such as relational databases and flat file systems that use magnetic disk storage and/or solid state RAM.

While the phrase “click” may be used with respect to a user selecting a control or the like, other user inputs may be used, such as voice commands, text entry, gestures, etc.

Many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, the use of particular terminology when describing certain features or aspects of the invention should not be taken to imply that the terminology is being re-defined herein to be restricted to including any specific characteristics of the features or aspects of the invention with which that terminology is associated.

1. A matching system, the matching system comprising:
at least one computing device;
non-transitory memory storing instructions, which when executed by the at least one computing device, are configured to cause the matching system to perform operations comprising:
receiving profile information for a first plurality of users;
determining that a first user in the first plurality of users is accessing a first user interface;
identifying a plurality of matching users from the first plurality of users based at least in part on the received profile information;
ranking the identified plurality of matching users based at least in part on a first criterion;
determining a first ordering of a match feed in which respective profile information of the identified plurality of matching users are to be presented in a first area of a first user interface to the first user based at least in part on respective rankings;
enhancing placement of profile information of a second user with respect to at least the first ordering of the match feed at least partly in response to an enhanced placement fee from the second user;
presenting profile information of a first matching user in a first area;
providing, via the first user interface, a backward feed navigation control and a forward feed navigation control, wherein in response to the user navigating forward, by activating the forward feed navigation control, through the first ordering of the match feed from the profile information of the first matching user in a first increment, profile information of a second matching user is displayed in the first area, and in response to the first user navigating backward, by activating the backward feed navigation control, through the first ordering of the match feed from the profile information of second matching user in the first increment, the profile information of the first matching user is displayed in the first area;
dynamically reordering the feed ordering to provide a second feed ordering at least partly in response to a detection of:
at least one of the identified plurality of matching users indicating an interest in the first user; or
at least one of the identified plurality of matching users visiting a profile of the first user; or
at least one of the identified plurality of matching users providing a gift to the first user; or
at least one of the identified plurality of matching users providing a request that respective profile information of the at least one of the identified plurality of matching users be provided with enhanced placement;
at least partly in response to the first user navigating forward through the second ordering of the match feed from the profile information of the first matching user in the first increment, profile information of a third matching user is displayed in the first area instead of the second matching user.

2. The system as defined in claim 1, wherein the system is configured to sequentially present profiles of two or more users in the first area in response to the first user activating an advance feed control.

3. The system as defined in claim 1, wherein the profile information regarding the third matching user is presented in the first area of the first user interface partly in response to the first user activating an advance feed control.

4. The system as defined in claim 1, wherein the system is further configured to automatically transmit a notification to at least one user whose profile was provided for display to the first user, the notification indicating that the at least one user's profile was viewed.

5. The system as defined in claim 1, the operations further comprising:
receiving a first indication from the first user that the first user is not interested in at least one user whose profile information is presented in the first area of the first user interface;
at least partly in response to receiving the first indication from the first user that the first user is not interested in the at least one user, storing an indication that the profile information for at least one user is not to be presented in the future to the first user as a match.

6. The system as defined in claim 1, wherein the system is further configured to automatically transmit a notification to at least one user whose profile was provided for display to the first user, the notification indicating that the first user indicated an interest in the at least one user's profile.

7. The system as defined in claim 1, wherein the system is further configured to automatically transmit a notification to at least one user who is determined by the system to have had previously indicated an interest in the first user and whose profile was provided for display to the first user, the notification indicating that the first user indicated an interest in the at least one user's profile and that the at least one user's had indicated interest in the first user.

8. The system as defined in claim 1, wherein the system is further configured to determine if the first user viewed the profile information of the second matching user or indicated an interest in the second matching user, and at least partly in response, automatically transmit a notification to the second matching user, the notification including a link, that when activated causes at least in part profile information associated with the first user to be presented to the second matching user.

9. The system as defined in claim 1, wherein the system is further configured to determine if the first user viewed the profile information of the second matching user or indicated an interest in the second matching user, and at least partly in response, automatically transmit a notification to the second matching user, the notification including a link, that when activated causes the first user interface to be displayed to the second matching user, wherein profile information associated with the first user is presented in the first area in response to a user activating an advance feed control provided by the first user interface.

10. The system as defined in claim 1, wherein the system is further configured to determine if the first user viewed the profile information of the second matching user or indicated an interest in the second matching user, and at least partly in response, automatically transmit a notification to the second matching user, the notification including a link, that when activated causes at least in part profile information associated with the first user to be presented to the second matching user in the first area of the first user interface.

11. The system as defined in claim 1, wherein the system is further configured to cause a system message in response to a first system event to be displayed in the first area of the first user interface, and to cause a gift message to be displayed in the first area at least partly in response to at least one user sending the first user a gift.

12. The system as defined in claim 1, wherein the first criterion includes location-related information.

13. The system as defined in claim 1, wherein the system is configured to indicate to the first user, in association with a profile of a given matching user, whether the given matching user has indicated an interest in the first user.

14. The system as defined in claim 1, wherein the system is configured to transmit a notification to the first user when a new matching user has been identified.

15. The system as defined in claim 1, wherein the system is further configured to:
store historical information:
regarding which profiles from the identified plurality of matching users have been provided for display to the first user, and
regarding an ordering of the profiles from the identified plurality of matching users provided for display to the first user; and
provide navigation controls enabling the user to navigate backwards through profile information for respective users in the identified plurality of matching users previously presented to the first user based at least in part on the historical information.

16. (canceled)

17. The system as defined in claim 1, wherein the profile information regarding the first matching user is presented via a virtual card.

18. The system as defined in claim 1, wherein only one profile is displayed in the first area at a time.

19. The system as defined in claim 1, wherein the profile information of the second user comprises a pre-recorded video including an audio track.

20. The system as defined in claim 1, wherein the profile information of the second user comprises a webcam feed, wherein the webcam feed provides a live video feed, wherein the feed is displayed in the first area of the first user interface.

21. The system as defined in claim 1, wherein enabling the first user to communicate with the second matching user further comprises enabling the first user to communicate with the second matching user using video chat.

22. The system as defined in claim 1, wherein the system is configured to dynamically reorder at least a portion of the profiles from the identified plurality of matching users provided for display to the first user based at least in part on a first input from the first user.

23. The system as defined in claim 1, wherein ordering the identified plurality of matching users is based at least in part on whether respective profiles of the identified plurality of matching users includes a pre-recorded video and/or a webcam feed.

24. The system as defined in claim 1, wherein the system is configured to provide for display to the first user additional profile information, for at least one of the identified plurality of matching users in response to the first user indicating an interest in the at least one of the identified plurality of matching users, relative to initial profile information provided for display in the first area for the at least one of the identified plurality of matching users.

25. The system as defined in claim 1, wherein the system is configured to store:
indications of interest by the first user in at least a portion of the plurality of matching users in association with respective time stamps as to when the indications of interest were received by the system;
indications of views by the first user of profile information for at least a portion of the plurality of matching users in association with respective time stamps as to when the views occurred;
indications of gifts provided by the first user to at least a portion of the plurality of matching users in association with respective time stamps as to when the gifts were provided by the first user; and
indications of requests from the first user that profile information of the first user be provided with enhanced placement with respect to a subset of other users.

26. The system as defined in claim 1, wherein the re-ordering is based at least in part on one time stamp.

27. The system as defined in claim 1, wherein the system is configured to order a contact list of the first user based at least in part on a whether a given contact in the contact list has sent a message to the first user that is in an unread state.

28. The system as defined in claim 1, wherein the system is configured to order a contact list of the first user based at least in part on a whether a given contact in the contact list is online.

29. A computer implemented method, comprising:
receiving at a computing system profile information for a first plurality of users;
determining by the computing system that a first user in the first plurality of users is accessing a first user interface;
identifying by the computing system a plurality of matching users from the first plurality of users based at least in part on the received profile information;
ranking by the computing system the identified plurality of matching users based at least in part on a first criterion;
determining by the computing system a first ordering of a match feed in which respective profile information of the identified plurality of matching users are to be presented in a first area of a first user interface to the first user based at least in part on respective rankings;
enhancing, by the computer system, placement of profile information of a second user with respect to at least the first ordering of the match feed at least partly in response to an enhanced placement fee from the second user
based at least in part on the determined ordering, causing at least in part by the computing system, profile information regarding a first matching user to be presented in the first area of the first user interface in association with a communication initiation control;
providing, via the first user interface, a backward feed navigation control and a forward feed navigation control, wherein in response to the user navigating forward, by activating the forward feed navigation control, through the first ordering of the match feed from the profile information of the first matching user in a first increment, profile information of a second matching user is displayed in the first area, and in response to the first user navigating backward, by activating the backward feed navigation control, through the first ordering of the match feed from the profile information of second matching user in the first increment, the profile information of the first matching user is displayed in the first area;
dynamically reordering, by the computing system, the feed ordering to provide a second feed ordering at least partly in response to a detection of:
at least one of the identified plurality of matching users indicating an interest in the first user; or
at least one of the identified plurality of matching users visiting a profile of the first user; or
at least one of the identified plurality of matching users providing a gift to the first user; or
at least one of the identified plurality of matching users providing a request that respective profile information of the at least one of the identified plurality of matching users be provided with enhanced placement;
at least partly in response to the first user navigating forward through the second ordering of the match feed from the profile information of the first matching user in the first increment, profile information of a third matching user is displayed in the first area instead of the second matching user.
